(19) United States
(12) Patent Application Publication
(10) Pub. No.: US 2011/0075860 A1
(43) Pub. Date: Mar. 31, 2011

(54) SOUND SOURCE SEPARATION AND DISPLAY METHOD, AND SYSTEM THEREOF

(76) Inventors: Hiroshi Nakagawa, Tokyo (JP); Kazuhiro Takashima, Tokyo (JP); Kunikazu Hirosawa, Tokyo (JP)

(21) Appl. No.: 12/993,440

(22) PCT Filed: May 29, 2009
(86) PCT No.: PCT/JP2009/059885

§ 371 Date: Nov. 18, 2010

(30) Foreign Application Priority Data
May 30, 2008 (JP) 2008-143079
Nov. 21, 2008 (JP) 2008-298650

(51) Int. Cl. H04B 15/00

(52) U.S. Cl. 381/94.1

(57) ABSTRACT

The present invention relates to a sound source separation and display method and a system thereof, and provides in particular a sound source separation and display method and a system thereof that are intended to eliminate a specific sound source. In order to separate a plurality of sound sources by using a single set of microphone array, the result of processing of sound source identification is utilized. More specifically, a signal in a direction is extracted from the result of the processing of the sound source identification, and a field limited to/eliminated of the effect of the signal is calculated and displayed. Such an operation can be repeated. A virtual reference signal can be created in a time domain.

### TECHNICAL FIELD

The present invention relates to a sound source display method and a system thereof, and more particularly to a sound source separation and display method and a system thereof which are intended to eliminate a specific sound source.

### BACKGROUND ART

A measurement system using a microphone array, which is a combination of a plurality of microphones, is widely used to identify and visualize the incoming directions of sound and the sound sources. The measurement system can be configured with only a single microphone array, or can also use several reference signal sensors such as a microphone and a vibration pickup.

A microphone array by itself is used to equally evaluate sound sources lying in the intended direction of the microphone array. For example, a microphone array of planar shape is intended to analyze sound sources in the front direction. A spherical microphone array is intended to analyze sound sources in all directions around the sphere. If target sounds have high sound pressure levels and show sufficient S/N ratios with respect to other background noise, the locations of the sound sources or the incoming directions can be analyzed without a reference signal. Digital signal processing can be applied for mechanical determination.

On the other hand, when reference signal sensors are used in combination, signals highly correlated with the signals of the reference signal sensors are typically separated by digital signal processing. For example, targeting at automotive noise, reference sensors for providing high-quality sound source information on various sound sources are installed in several appropriate locations. Signals such as one having high correlation with the engine operation, one having high correlation with inputs from the road surface, and one having high correlation with wind noise are each separated. In such a case, the locations where the reference signals highly correlated with the noise observed in the vehicle interior derive from need to be known in advance so that vibration pickups or microphones are installed at/near the locations. The locations to acquire the reference signals need to be appropriately defined in advance, or a considerable number of reference signal sensors need to be installed so that signals of high contribution are selected from among them.

In actual noise phenomena, it is often difficult to identify where the sound sources are. For example, when noise with a predominant pure sound component is observed in a closed space, it is extremely difficult to determine by only human senses (sense of hearing) where the sound occurs from. To solve the problem, there has been “virtual reference” methods of virtually creating reference signals without the installation of reference signal sensors.

NPL 1 describes a method of analysis in which a beam forming (BF) microphone array capable of providing sharp directionality by post processing is installed in addition to a nearfield acoustic holography (NAH) microphone array in order to acquire reference signals for use in near field acoustic holography which is an essential calculation means for sound source probing. The incoming direction of a strong sound source is initially estimated by using a MUSIC method. Sharp directionality to the resulting direction is formed by BF, and sound coming from that direction is extracted and used as a reference signal for nearfield acoustic holography. With such a technique, if there are a plurality of sound sources, it is possible to acquire a plurality of reference signals by post processing, and obtain partial fields which are the results highly correlated with the respective corresponding reference signals (NPL 1).

As another means, there is a technique of calculating and visualizing partial fields by using only an NAH microphone array. According to the technique, the peaks of NAH-based estimated sound pressures are used as virtual reference signals, and the effects of the peaks are eliminated for visualization. Such processing can be repeated to visualize second and third weak sound sources (PTL 1 and NPL 2).

### Citation List

### Patent Literature

PTL 1: U.S. Pat. No. 6,958,950

### Non-Patent Literature

NPL 1: “Beamforming based partial field decomposition in acoustical holography,” J. of Kor. Soc. for Noise and Vib. Eng., v. 11, No. 6, 2001, p. 200.

NPL 2: “A partial field decomposition algorithm and its examples for nearfield acoustic holography,” J. Acoust. Soc. Am. 116 (1), 2004, p. 172-.

### DISCLOSURE OF INVENTION

### Technical Problem

With the method of NPL 1, no reference microphone needs to be installed near target sound sources, whereas another set of microphone array needs to be installed at a distance. Such a microphone array can be considered as a reference signal sensor, or equivalently, the technique needs a reference signal sensor after all. The method of PTL 1 and NPL 2 is only used to visualize weak sound sources on a sound pressure map that is obtained by nearfield acoustic holography. Specialized in the computations of nearfield acoustic holography, the method has had no generality for application to other techniques. The nearfield acoustic holography can accurately predict the sound field near the microphone array, and can obtain accurate sound source information if the microphone array is installed close to sound sources. On the other hand, if sound sources are far from the microphone array, it is not possible to provide exact information on the far sound sources even though the sound field in the vicinity of the microphone array can be accurately predicted. The difficulty in obtaining information that serves as a guideline for noise control has been one of the problems.

The present invention has been achieved in view of the circumstances, and it is an object of the present invention to solve the foregoing problems.

### Solution to Problem

A sound source separation and display method according to the present invention is a sound source separation and display method that includes: an acoustic signal measurement step of measuring acoustic signals by using a plurality of acoustic sensors; a sound source signal extraction step of performing processing to identify one or a plurality of sound sources from the measured acoustic signals, and extracting a sound source signal in a certain incoming direction or at a certain location; and a specific sound source elimination step of eliminating an effect of a specific sound source from the measured acoustic signals by separating a component correlated with a virtual reference signal from the measured acoustic signals with the signal extracted by the sound source signal extraction step as the virtual reference signal, and performing the processing to identify one or a plurality of sound sources again on the signals from which the effect of the specific sound source is eliminated and separated, thereby eliminating only the effect of the specific sound source from a result of the processing to identify the sound source(s), the method being capable of displaying a sound source separated.

In the sound source separation and display method according to the present invention, the sound source signal extraction step and the specific sound source elimination step are performed a plurality of times.

In the sound source separation and display method according to the present invention, the specific sound source elimination step estimates the certain incoming direction or a position of the specific sound source and calculates magnitudes of effects of the plurality of sound sources in order to create the virtual reference signal.

In the sound source separation and display method according to the present invention, the specific sound source elimination step estimates a rank of a cross spectrum matrix of the acoustic signals, and determines an upper limit of the number of times of elimination, the rank pertaining to the number of uncorrelated sound sources

In the sound source separation and display method according to the present invention, the sound source(s) is/are visualized in combination with images captured by light receiving elements that are arranged like the acoustic sensors.

A sound source separation and display system according to the present invention is a sound source separation and display system that is capable of displaying: an acoustic signal measuring means for measuring acoustic signals by using a plurality of acoustic sensors; a sound source signal extracting means for performing processing to identify one or a plurality of sound sources from the measured acoustic signals, and extracting a sound source signal in a certain incoming direction or at a certain location; a specific sound source eliminating means for eliminating an effect of a specific sound source from the measured acoustic signals by separating a component correlated with a virtual reference signal from the measured acoustic signals with the signal extracted by the sound source signal extracting means as the virtual reference signal, and performing the processing to identify one or a plurality of sound sources again on the signals from which the effect of the specific sound source is eliminated and separated, thereby eliminating only the effect of the specific sound source from a result of the processing to identify acoustics; and a sound source separated.

In the sound source separation and display system according to the present invention, the sound source signal extracting means and the specific sound source eliminating means are performed a plurality of times.

In the sound source separation and display system according to the present invention, the specific sound source eliminating means includes a means for estimating an incoming direction of a certain sound wave or a position of the specific sound source and calculating magnitudes of effects of the plurality of sound sources in order to create the virtual reference signal.

In the sound source separation and display system according to the present invention, the specific sound source eliminating means includes a means for estimating a rank of a cross spectrum matrix of the acoustic signals, and determining an upper limit of the number of times of elimination, the rank pertaining to the number of uncorrelated sound sources.

The sound source separation and display system according to the present invention includes a means for visualizing the sound source(s) in combination with images captured by light receiving elements that are arranged like the acoustic sensors.

### Advantageous Effects of Invention

According to the present invention, there is no need for a microphone for acquiring a reference signal. Even if the target noise phenomenon is so weak as to be hidden by other noise, it is therefore easily possible to perform measurement and evaluation, and noise-reducing measures can be taken effectively and easily. According to the present invention, it is also possible to create a virtual reference signal in a time domain. This allows a wide range of applications to directional digital filter processing including a beam forming method, aside from nearfield acoustic holography. Arbitrary acoustic signals can be emphasized or hidden even in the absence of a sufficient S/N ratio and/or in the presence of a plurality of sound sources.

### BRIEF DESCRIPTION OF DRAWINGS

FIG. 1 is a block diagram of a specific sound source display system according to embodiment 1 of the present invention.

FIG. 2 is a control block diagram of a server according to embodiment 1 of the present invention.

FIG. 3 is a conceptual diagram of the result of specific sound source elimination according to embodiment 1 of the present invention.

FIG. 4 is a conceptual diagram of the specific sound source elimination according to embodiment 1 of the present invention.

FIG. 5 is a chart showing specific sound source elimination processing according to embodiment 1 of the present invention.

FIG. 6 is a chart showing a sound source signal extraction step according to embodiment 1 of the present invention.

FIG. 7 is a conceptual diagram of the specific sound source elimination processing according to embodiment 1 of the present invention.

FIG. 8 is a conceptual diagram showing a specific sound source elimination step according to embodiment 1 of the present invention.

FIG. 9 is a chart showing the specific sound source elimination step according to embodiment 1 of the present invention.

FIG. 10 is a control block diagram of a server according to embodiment 2 of the present invention.

FIG. 11 is a chart showing specific sound source elimination processing according to embodiment 2 of the present invention.

FIG. 12 is a chart showing a sound source signal extraction step according to embodiment 2 of the present invention.

FIG. 13 is a chart showing a specific sound source elimination step according to embodiment 2 of the present invention.

FIG. 14 is a chart showing acoustic signal cross spectrum matrix calculation according to embodiment 2 of the present invention.

FIG. 15 is a diagram showing the results of experiments that were performed in examples 1 to 4.

FIG. 16 is a schematic diagram of the experiments performed in examples 1 to 4 and photographs at the time of actual measurement.

FIG. 17 is a diagram showing an example of the analysis result of example 1 where the open angle between the sound sources was 30°.

FIG. 18 is a diagram showing an example of the analysis result of example 1 where the open angle between the sound sources was 60°.

FIG. 19 is a diagram showing an example of the analysis result of example 1 where the open angle between the sound sources was 90°.

FIG. 20 is a diagram showing an example of the analysis result of example 1 where the open angle between the sound sources was 180°.

FIG. 21 is a diagram showing an example of the analysis result of example 2 where the open angle between the sound sources was 30°.

FIG. 22 is a diagram showing an example of the analysis result of example 2 where the open angle between the sound sources was 60°.

FIG. 23 is a diagram showing an example of the analysis result of example 2 where the open angle between the sound sources was 90°.

FIG. 24 is a diagram showing an example of the analysis result of example 2 where the open angle between the sound sources was 180°.

FIG. 25 is a diagram showing an example of the analysis result of example 3 where the open angle between the sound sources was 30°.

FIG. 26 is a diagram showing an example of the analysis result of example 3 where the open angle between the sound sources was 60°.

FIG. 27 is a diagram showing an example of the analysis result of example 3 where the open angle between the sound sources was 90°.

FIG. 28 is a diagram showing an example of the analysis result of example 3 where the open angle between the sound sources was 180°.

FIG. 29 is a diagram showing an example of the analysis result of example 4 where the open angle between the sound sources was 30°.

FIG. 30 is a diagram showing an example of the analysis result of example 4 where the open angle between the sound sources was 60°.

FIG. 31 is a diagram showing an example of the analysis result of example 4 where the open angle between the sound sources was 90°.

FIG. 32 is a diagram showing an example of the analysis result of example 4 where the open angle between the sound sources was 180°.

FIG. 33 is a diagram showing an example of the analysis result of vehicle interior noise before sound source elimination processing of example 5.

FIG. 34 is a diagram showing an example of the analysis result of noise contribution from the part of an A-pillar of example 5.

FIG. 35 is a diagram showing an example of the analysis result of example 5 where the noise contribution from the part of the A-pillar was eliminated.

FIG. 36 is a diagram showing an example of the analysis result of vehicle interior noise before sound source elimination processing of example 6.

FIG. 37 is a diagram showing an example of the analysis result of example 6 where a user puts an extraction point in an optimum position.

FIG. 38 is a diagram showing an example of the analysis result of example 6 where the user puts the extraction point in a non-optimum position.

### REFERENCE SIGNS LIST

5: network

100, 101: server

110: input unit

120: storing unit

130: acoustic signal extraction unit

140: virtual reference creation unit

150: control unit

160: output unit

170: acoustic signal cross spectrum matrix calculation unit

200-1 to 200-n: acoustic sensor

X: sound source display system

### DESCRIPTION OF EMBODIMENTS

Best mode of the present invention will be described with reference to the drawings.

### First Embodiment

### [System Configuration]

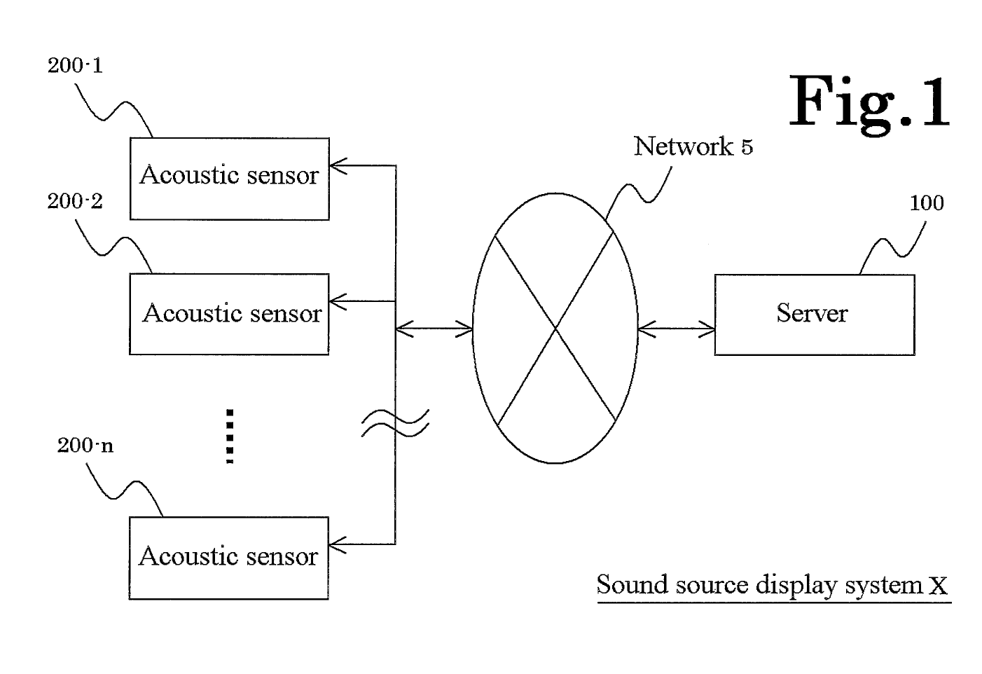

Referring to FIG. 1, the configuration of a sound source display system X according to an embodiment of the present invention will be described.

In the sound source display system X according to the embodiment of the present invention, acoustic sensors 200-1 to 200-n are connected to a server 100 (specific sound source elimination apparatus) which actually executes the sound source display, through a network 5 such as the Internet and an intranet. The acoustic sensors 200-1 to 200-n maybe arbitrary acoustic sensor devices for measuring sound pressure or particle speed, such as a microphone array for measuring sound pressure signals and acoustic particle speed sensors for measuring particle speed signals. The position of each acoustic sensor has arbitrary three-dimensional coordinates (x, y, z) so as to identify which acoustic sensor 200-1 to 200-n an acquired sound derives from. The acoustic sensors 200-1 to 200-n are preferably made of a sound source identification and measurement apparatus that includes a microphone array having a plurality of microphones on a baffle, described in PCT/JP2003/010851 and PCT/JP 2008/050632. More specifically, the acoustic sensors 200-1 to 200-n are composed of microphones, microphone extension cords, microphone amplifiers, A/D converters, a data communication unit equipped with various types of interfaces, etc. The data communication unit also includes a connecting means to the network 5, such as a LAN interface.

Nondirectional or directional microphones may be used. For higher identification accuracy, filters specific to respective frequency bands and filters tailored to a target sound source may be used for the output signals of the microphones. Frequency band characteristic filters are arranged in the reception system subsequent to the microphones. Among examples of the filters tailored to a target sound source are an order tracking filter that is synchronous with the number of engine revolutions in the case of automotive engine noise, and a filter that has an arbitrary frequency characteristic corresponding to the frequency characteristic of target noise. The sound pressure signals are electrical analog signals collected by the microphones, and are converted into digital signals by A/D conversion units.

The acoustic sensors 200-1 to 200-n can sample the sound pressure signals or the like measured by the microphones, and transmit data on the time variations (time series) of the signals through the LAN interface or the like almost in real time. Here, actual sound pressure waveforms are digitally sampled, for example, with CD-equivalent or suchlike sound quality in 16 bits with a sampling frequency of 44.1 kHz. The waveforms may sometimes be compressed for transmission by using a lossless codec which is capable of full restoration of the original waveforms. The data is then transmitted in accordance with the configuration of the foregoing network 5.

The network 5 may be any network such as a LAN, power line LAN, cLink, wireless LAN, cellular phone or PHS network, fixed phone line, and dedicated line as long as the network has a line speed capable of the transfer rate of the audio data. For the network configuration, an IP network and other star and ring networks may be employed. The data may be exchanged through a storing medium such as a flexible disk, various flash memory cards, and a HDD (Hard Disk Drive).

The server 100 is a PC/AT-compatible PC server, a general-purpose machine, or the like. The server 100 executes a program that is intended to provide the functions of analyzing the acoustic signal data from the acoustic sensors 200-1 to 200-n, and eliminating only the effect of a specific sound source from the result of sound source identification and measurement by using a virtual reference signal that is created by extracting one or a plurality of acoustic signals lying in a desired direction.

### [Control Configuration]

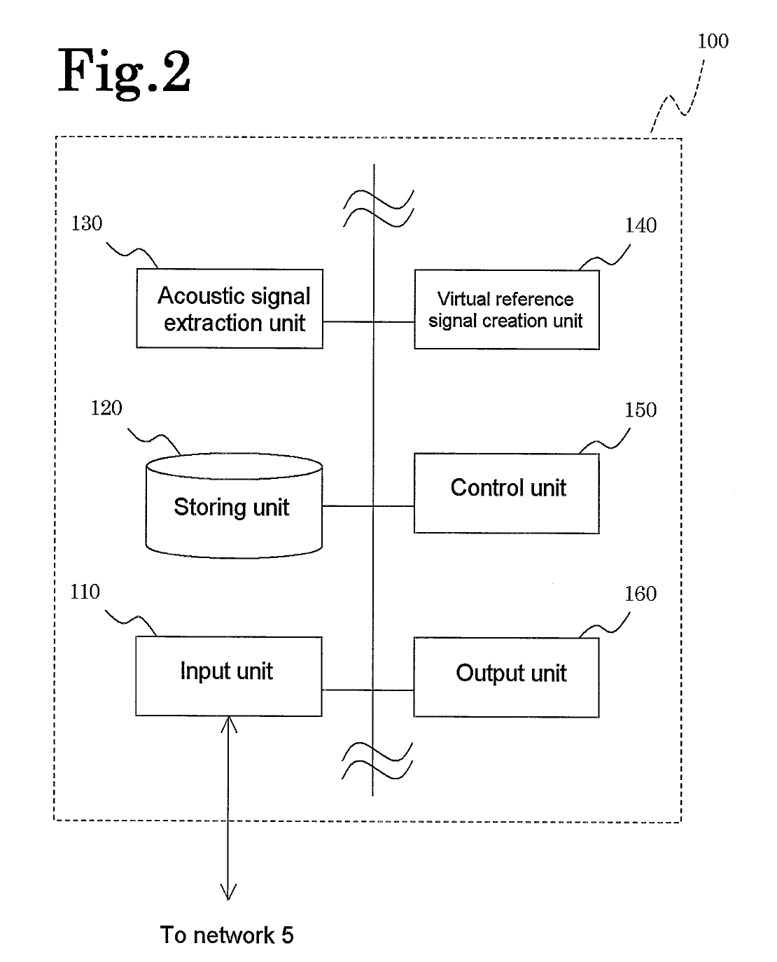

Next, the control configuration of the server 100 according to the embodiment of the present invention will be described in more detail with reference to FIG. 2.

The server 100 is a component that is capable of analysis and operations of acoustic signal data, and mainly includes: an input unit 110 (inputting means) which inputs the acoustic signal data acquired by the acoustic sensors 200-1 to 200-n; a storing unit 120 (storing means) which stores the input data, extraction data on acoustic signals, the algorithm of directional digital filter processing, the result of specific sound source elimination, and so on; an acoustic signal extraction unit 130 (acoustic signal extracting means) which extracts acoustic signals coming from a certain direction or at a certain location; a virtual reference signal creation unit 140 (virtual reference signal creating means) for creating a virtual reference signal which is extracted by the directional digital filter processing; a control unit 150 (specific sound source eliminating means) such as a CPU (Central Processing Unit) and an MPU (Micro Processing Unit); and an output unit 160 (outputting means) such as an LCD display or other display unit, a printer, a plotter, and a waveform output device.

To create data for the acoustic signals to be extracted from and the virtual reference signal, the server 100 may acquire the data detected by the acoustic sensors 200-1 to 200-n, may directly acquire information on other sensors, information sites, and the like from the network 5, and may directly acquire such information from a storing medium.

More specifically, the input unit 110 is a LAN interface or the like, and includes an input means such as a keyboard, pointing device, and optical/magnetic scanner. The input unit 110 can thus input the data from the acoustic sensors 200-1 to 200-n, data previously measured by a measurement operator, etc. The input unit 110 may further include a user interface through which the measurement operator inputs the type and other factors of the acoustic signal data input from the sensors 200-1 to 200-n.

The storing unit 120 is a RAM, ROM, flash memory, HDD, or the like . The storing unit 120 can store the acoustic signal data input from the acoustic sensors 200-1 to 200-n, acoustic signal data previously measured by the measurement operator, algorithms for use in the directional digital filter processing of beam forming method, nearfield holography, and the like, programs and necessary data as to the result of specific sound source elimination, etc.

For the acoustic signal extraction unit 130 and the virtual reference signal creation unit 140, it is preferred to use arithmetic units that are capable of real-time operations, such as a dedicated arithmetic DSP (Digital Signal Processor), a physical calculation-specific arithmetic unit, and a GPU (Graphics Processing Unit). The functions of the acoustic signal extraction unit 130 and the virtual reference signal creation unit 140 may be implemented by using the arithmetic functions of the control unit 150.

The control unit 150 is a component that performs control and operations when actually performing specific sound source elimination processing to be described later. The control unit 150 performs various types of controls and arithmetic processing on the acoustic signal data, which are digital signals converted by A/D converters, according to the program stored in the ROM, HDD, or the like of the storing unit 120.

### [Concept of Specific Sound Source Elimination]

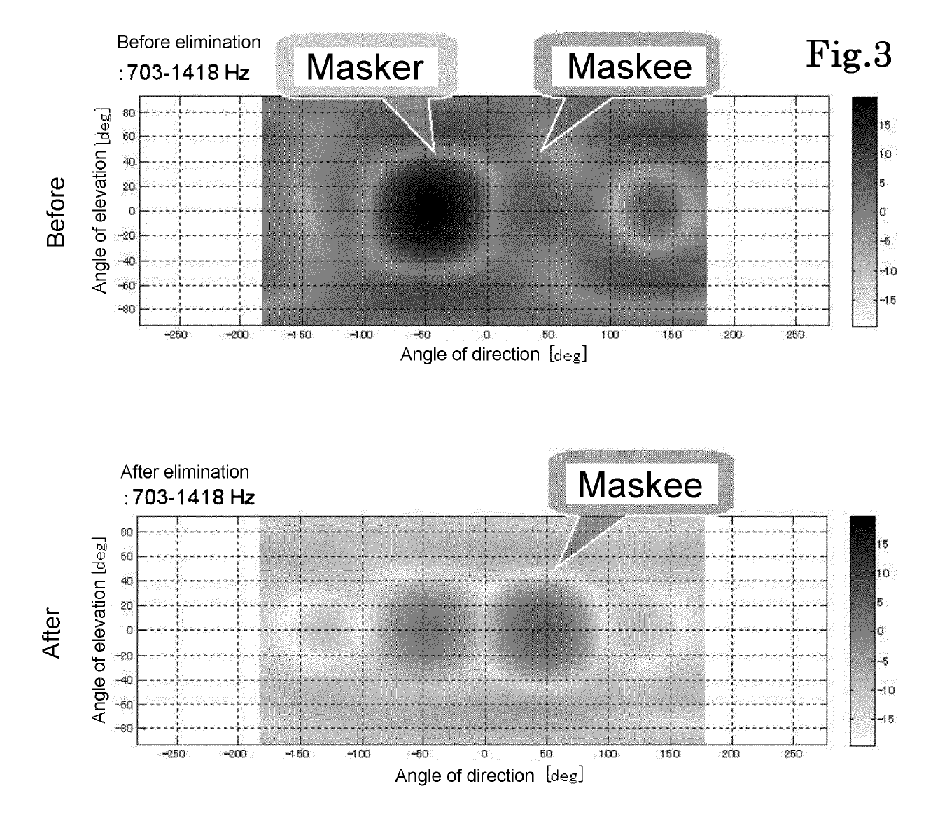

As shown in the conceptual diagram of a result of specific sound source elimination in FIG. 3, according to the present invention, a masker or a sound to be eliminated is identified and eliminated to extract a maskee, a sound to emerge. The masker is a masking sound, typically a primary sound source that shows a high sound pressure level but is to be eliminated for the sake of analysis. The maskee is a sound to be masked, typically a sound that is hidden by the effect of the primary sound source but to be the target of noise control. The horizontal axis indicates the angle of direction, and the vertical axis the angle of elevation.

The upper chart of FIG. 3 shows a masker and a maskee before the elimination of the masker. The masker is a white noise (+20 dB) and the maskee is a white noise. Both fall within 1/1 octave band with a center frequency of 1 kHz. The lower chart of FIG. 3 shows the result of sound source display after the elimination of the masker shown in the upper chart of FIG. 3. It can be seen that the elimination of the masker uncovers the hidden maskee.

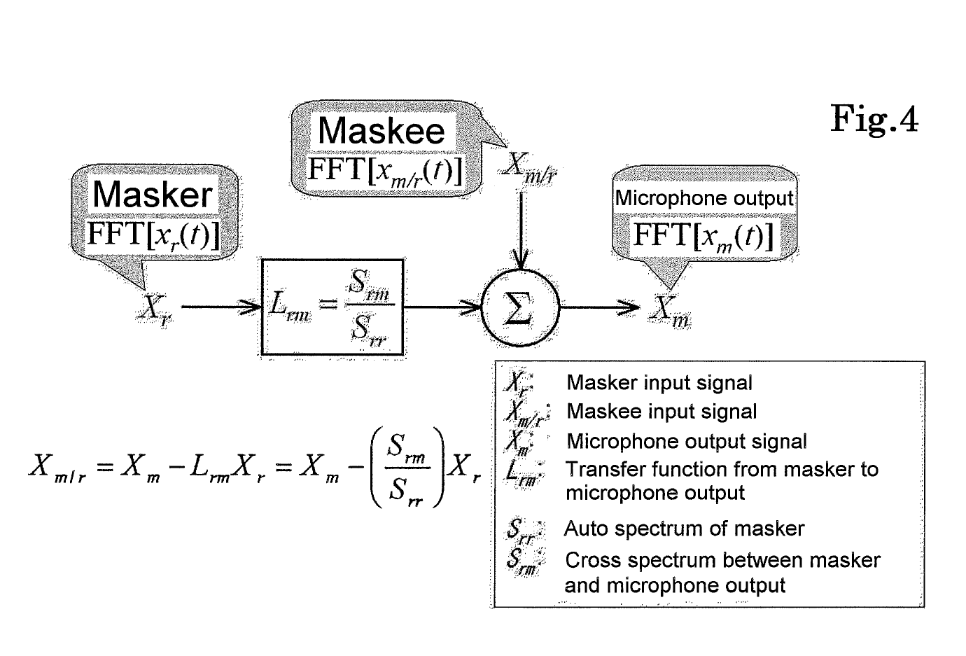

The concept of the specific sound source elimination method of the present invention will be described in conjunction with a two-input system of FIG. 4. Xr is defined to be a masker input signal, Xm/r a maskee input signal, Xm the output signal of a microphone, Lrm a transfer function from the masker to the microphone output, Srr the auto spectrum of the masker, and Srm a cross spectrum between the masker and the microphone output. The microphone output, i.e., the signal of the sound recorded by the microphone is the sum of the masker signal and the maskee signal passing through the path that is expressed by the transfer function Lrm. To extract the maskee, the masker signal passing through the transfer function Lrm is therefore subtracted from the output signal of the microphone. The equation for determining the maskee signal is shown to the bottom in FIG. 4.

### [Specific Sound Source Elimination Processing]

Specific sound source elimination processing can create a virtual reference signal in a time domain without the need for a microphone for acquiring a reference signal. The specific sound source elimination processing is an effective means for effective and easy implementation of measures that allow emphasis and separation of arbitrary acoustic signals so that the target noise phenomenon can be easily and accurately measured and evaluated for noise reduction. With such specific sound source elimination processing, it has been needed to specify the incoming direction or location of the masker by hand. Then, the following processing was devised to extract a virtual reference signal without the manual elimination processing.

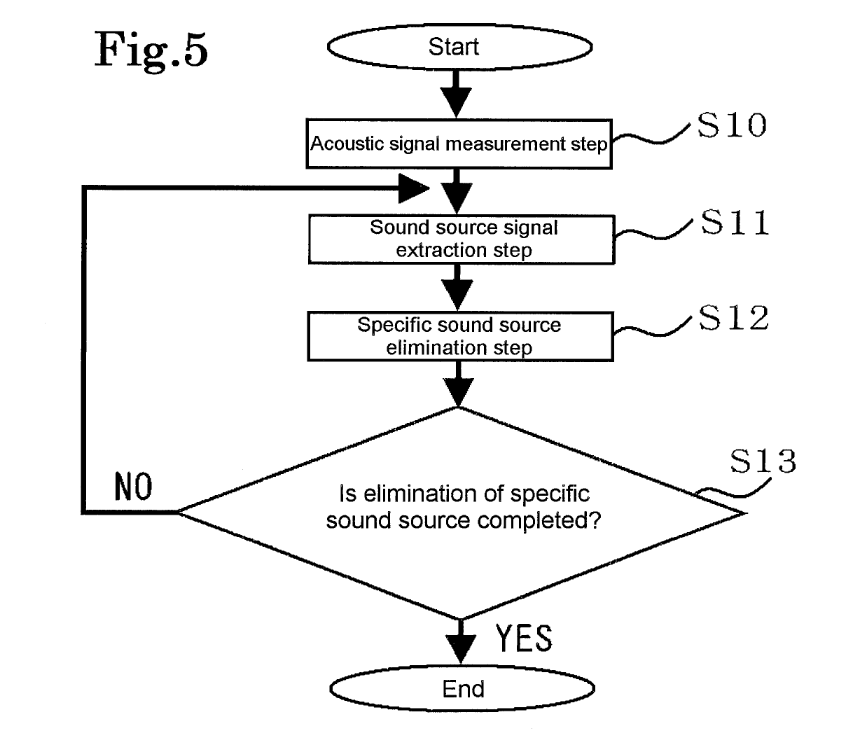

As shown in FIG. 5, the specific sound source elimination processing of the present invention generally includes an acoustic signal measurement step S10, a sound source signal extraction step S11, a specific sound source elimination step S12, and a step S13 of determining whether the elimination of a specific sound source is completed.

### [Acoustic Signal Measurement Step]

Description will be given of the acoustic signal measurement step S10 that was performed by using the sound source identification and measurement apparatus described in PCT/JP2003/010851 and PCT/JP 2008/050632 and the implemented software.

The description of the present embodiment will deal with a case where the acoustic signal measurement step S10 uses only a single set of microphone array which includes 31 microphones. The greater the number of microphones is, the more the result of sound source identification improves in accuracy and stability. Sound source identification is possible, however, at least with a minimum necessary number of microphones corresponding to the order of sound source identification. The microphone array is modified as appropriate depending on the use range, technique, and coordinate system for analysis. The microphone array may have a planar shape, two-dimensional shape, three-dimensional shape, or any arbitrary shape. Incidentally, planar shapes are the most commonly used, and have heretofore been commonly employed for nearfield acoustic holography and beam forming. Three-dimensional shapes apparently refer to a spherical shape, cylindrical shape, and the like, whereas such microphone arrays are a kind of two-dimensional microphone arrays when seen in the spherical coordinate system or cylindrical coordinate system. Arbitrary shapes have a higher degree of freedom due to the arrangement according to the object shape, but the exact positions of the microphones need to be known. Hereinafter, a concrete description will be given of the flow of the specific sound source elimination processing for the control unit 150 and the like to perform on the acoustic signals captured by the respective microphones. In any case, the algorithms of the nearfield acoustic holography and beam forming need to be modified as appropriate depending on the shape of the microphone array.

### [Sound Source Signal Extraction Step]

Description will be given of the sound source signal extraction step S11 that was performed by using the sound source identification and measurement apparatus described in PCT/JP 2003/010851 and PCT/JP 2008/050632 and the implemented software While acoustic signals coming from a certain direction or at a certain location can typically be extracted by beam forming, nearfield acoustic holography, and suchlike operations, it is understood that arbitrary algorithms, devices, and implemented software may be used. Here, description will be given in conjunction with the beam forming based algorithm described in PCT/JP 2003/010851 and PCT/JP 2008/050632.

The implemented software performs the directional digital filter processing of separating the sound sources of digitally-converted sound pressures signals by using a directional digital filter. Such processing is typically referred to as beam forming. The directional digital filter is a filter for separating sound sources that lie in all directions at the same time. The directional digital filter is defined depending on parameters such as the shape and size of the microphone array, the positions of the microphones, frequency, and the direction of separation, and is exercised by numerical calculations on sound pressure signals, electrical signals, and digital signals converted by A/D conversion units. In the beam forming operations, the directionality is changed across all operable directions so that each sound source signal is extracted and separated even if there are sound sources in a plurality of directions at the same time.

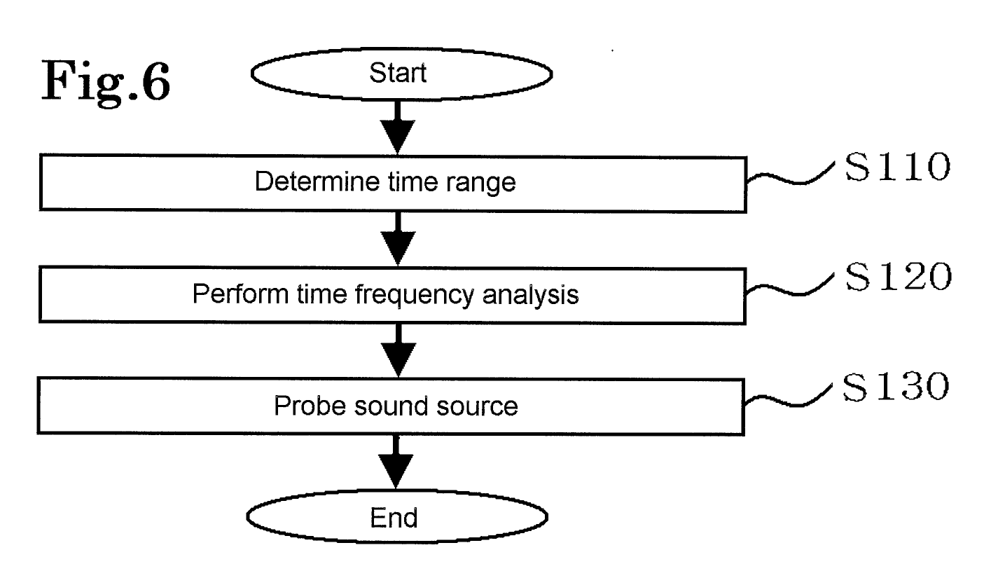

Specifically, as shown in FIG. 6, the sound source signal extraction step S11 includes the determination of a time range (step S110), time frequency analysis (step S120), and sound source probing (step S130). The steps will be detailed below.

### (Step S110)

Initially, the acoustic signal extraction unit 130 performs the determination of a time range. The acoustic signal extraction unit 103 determines the time range where to perform the analysis of the incoming direction and intensity of sound. Here, the time range in which the time waveform of the acquired acoustic signal data includes the sound from a target sound source is extracted as an analytical interval where to perform the analysis of the incoming direction and intensity of sound.

### (Step S120)

Next, the acoustic signal extraction unit 130 performs a time frequency analysis. The acoustic signal extraction unit 130 analyzes the time frequencies of the alternating-current waveforms of the acoustic signal data acquired by arbitrary acoustic sensors 200-1 to 200-n. If the noise under measurement is steady without much time change, the data on the time frequency analyses at respective times may be averaged. If the sound is unsteady, times where the sound is included are identified from the result of the time frequency analyses.

### (Step S130)

Next, the acoustic signal extraction unit 130 performs sound source probing. The acoustic signal extraction unit 130 implements the sound source probing of the sound source identification and measurement apparatus in the analytical interval, thereby determining the incoming directions of sounds and the intensities thereof (the degrees of contribution of the sounds at a time) in each unit time. Again, if the noise is steady, the intensities of the sound sources are determined from an averaged spectrum.

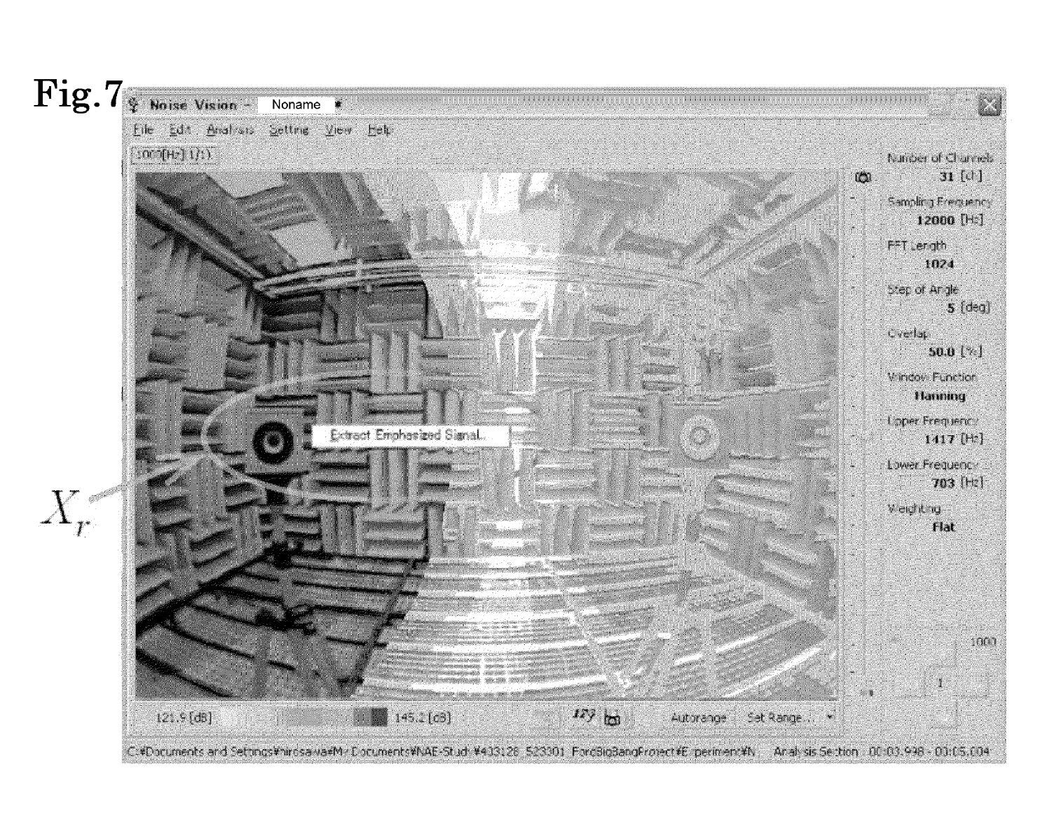

As described above, the amplitude characteristics and phase characteristics of the acoustic signals captured by the respective plurality of acoustic sensors 200-1 to 200-n are determined by arithmetic processing. Such signal information and sound field analysis information in the vicinity of the baffle are then integrated, and arithmetic processing of emphasizing sounds coming from a certain direction is performed in all directions. The incoming directions of the sounds from the sound sources are identified by the arithmetic processing. Consequently, the incoming directions of the sounds from the sound sources in all direction are identified and the sound intensities of the sound sources are estimated at the same time. When the incoming directions of the sounds from the sound sources are analyzed and the sound intensities of the sound sources are estimated by such arithmetic processing of the control unit 150, the results of the arithmetic processing may be displayed in color on the display device of the output unit 160 as a sound intensity distribution. FIG. 7 shows a composite image of the sound pressure levels and images obtained from a plurality of microphones and a plurality of light receiving elements that are arranged on a spherical baffle microphone of the sound source identification and measurement apparatus. In this example, the sound intensities are displayed in color on the display device. In FIG. 7, Xr represents an example of a masker signal to be eliminated, showing an example of operation where Xr is extracted by using software.

The signal extracted in the sound source signal extraction step S11 is used as a virtual reference signal in the following specific sound source elimination step S12.

### [Specific Sound Source Elimination Step]

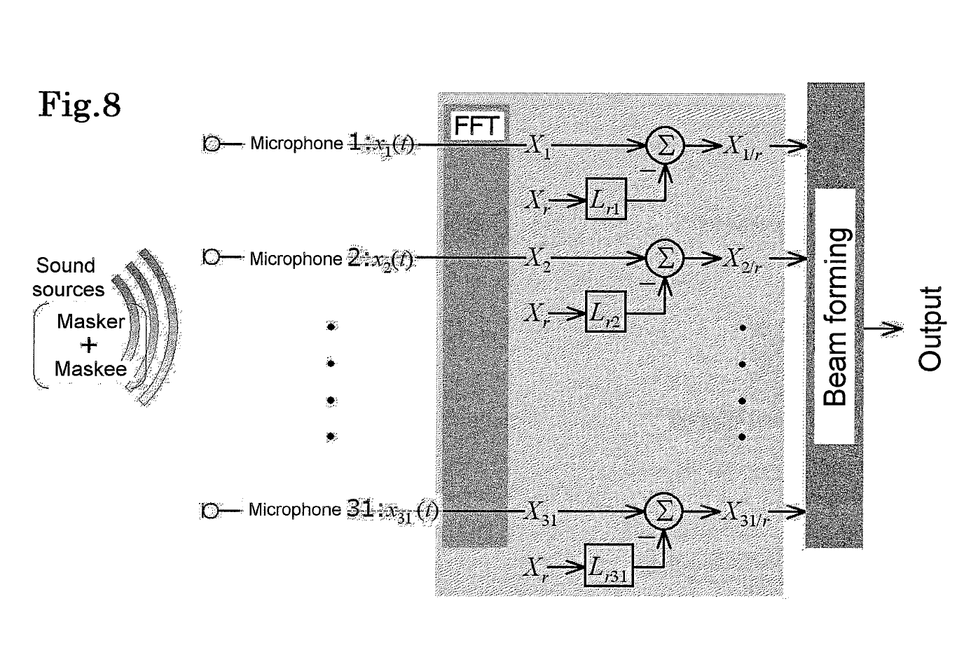

Description will be given with reference to the conceptual diagram of the specific sound source elimination step S12 in a 31-input system shown in FIG. 8. Mixed sound of a masker and a maskee is recorded by 31 microphones of the sound source identification and measurement apparatus. The microphones record time waveforms, whose frequency responses X1 to X31 are determined by a frequency analysis. The frequency analysis typically is FFT processing. To determine the frequency response Xr of the masker to be eliminated, the sound source identification and measurement apparatus then performs masker extraction in advance by using the function of emphasizing a signal in a certain direction. The resultant is assumed as a virtual reference signal. That is, the masker signal is regarded as equivalent to the virtual reference signal. Based on this, the transfer functions Lr1 to Lr31 between the masker and the respective microphones are calculated. The corresponding maskers (Lr1Xr to Lr31Xr) are subtracted from the respective microphone outputs X1 to X31 to extract maskees (X1/r to X31/r) in the respective microphones. The determined maskees are then analyzed by the directional digital filter processing, and the analysis is finally visualized for output.

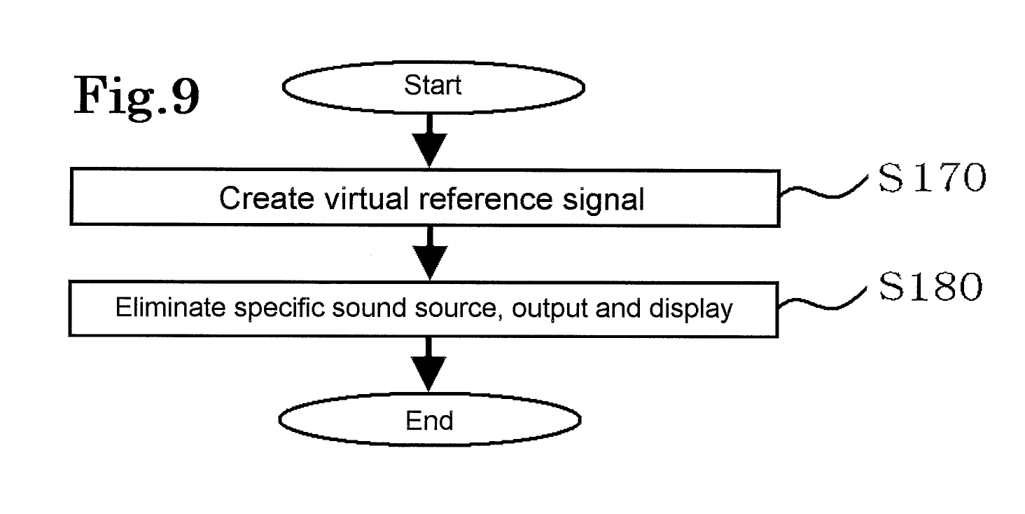

Specifically, as shown in FIG. 9, the specific sound source elimination step S12 includes the creation of a virtual reference signal (step S170) and the elimination of a specific sound source for output and display (step S180). The steps will be detailed below.

### (Step S170)

The virtual reference signal creation unit 140 performs the creation of a virtual reference signal. The virtual reference signal creation unit 140 creates a virtual reference signal by performing the directional digital filter processing on the result of sound source probing, which is the acoustic signals extracted in the foregoing sound source signal extraction step. In the present embodiment, the directional digital filter processing uses the algorithm of the beam-forming (BF) method, which needs only a single set of microphone array for BF. Nearfield acoustic holography (NAH) may be used to predict the sound pressure or particle speed near the microphone array, and the resultant may be used as a virtual reference.

Using a kind of approximation for its sound wave propagation model, BF is often used for the analysis of a far field where the microphone array is farther from the sound source than the wavelength. The sound source resolution depends on the size of the microphone array and the frequency. The greater the microphone array and the higher the frequency, the higher the resolution. Meanwhile, NAH is mathematically more rigid and includes less approximation, and can thus be used for analysis in the near field of a sound source. NAH is formulized with comparatively less approximation from wave equations. As compared to BF which includes the calculation of directional responses, there is a significant difference in that it is possible to estimate the sound pressure and particle speed near the microphone array. The sound source resolution is not dependent on the frequency, and high resolution analysis is possible even at low frequencies. It is difficult, however, to perform calculations at high frequencies where the directional responses can typically be calculated by BF.

As described above, the present invention utilizes the directional sound pressure determined by BF or the sound pressure or particle speed estimated by NAH as a virtual reference signal instead of using a physical reference sensor. This, in other words, this eliminates the need for a microphone for acquiring a reference signal. Using the virtual reference signal, the BF or NAH calculations may be repeated recursively. A specific sound elimination operation is to determine a result in which the effects of such signals are eliminated.

### (Step S180)

Next, the output unit 160 eliminates a specific sound source and performs output and display. Using virtual reference signals acquired, the output unit 160 repeats displaying partial fields, which are the results highly correlated with the respective reference signals, according to calculation steps. Here, the output is made in each of meshed sections corresponding to the two-dimensional coordinates on the screen, and the display device of the output unit 160 displays the output with contours in black and white, in color, etc Sound sources may be visualized and displayed in combination with images that are captured by CCD, CMOS, or other light receiving elements that are arranged like the acoustic sensors.

In embodiment 1 of the present invention, the directional signal acquired by beam forming or the sound pressure or particle speed predicted by nearfield acoustic holography is used as a virtual reference signal instead of using an additional physical sensor such as an additional microphone and a vibration pickup for a reference signal. This eliminates the need for a microphone array for acquiring a reference signal. Since the reference signal can be fully acquired by the measurement microphone array alone, the present invention can solve the problem that it is not possible to install a reference sensor such as a microphone and an acceleration pickup near a target or candidate unit in question when the intended equipment has various possible factors for noise generation. This solves the problem of physical complications with the technique of using two sets of microphone arrays.

Since it is possible to create “a reference signal in a time domain” which has been difficult to calculate by the conventional techniques, the reference signal can be applied not only to beam forming but also to other sound source probing techniques such as nearfield acoustic holography. Another significant feature is that the sound source signals are audible to engineers, so that the engineers can check the sound sources as an analysis object.

The reference signal acquired can be used to create a plurality of virtual reference signals depending on the frequency, the incoming direction or location of sound, and the like, and calculate corresponding partial fields. Conversely, it is also possible to calculate a sound source eliminated field where the effect of the reference signal is not included or the effect of the reference signal is eliminated. If the reference signal acquired thus has extremely high physical energy as compared to the other sound sources, the elimination of the affected partial fields means that other small noise phenomena being masked can be discovered easily. In other words, the elimination solves the problem if a sound to be detected or to take measures for has an insufficient S/N ratio and physical energy extremely lower than that of other sounds, the sound is inseparably hidden by the other sounds and it is difficult to measure or evaluate the target noise phenomenon. Another feature is that since the sound source elimination can be repeated to eliminate the effects of sound sources of high energy, it is possible to discover a masked second, third, and subsequent sound sources. The elimination of certain components from the sound in which various phenomena are simultaneously recorded makes it possible to actually hear hidden other sounds and use the sounds as information for a fault diagnosis etc.

From a mathematical point of view, such a virtual reference signal is the sum of the results of filtering of the signals from the respective elements of the microphone array. Due to the linear operation, the reference signal is partly correlated with all the microphones. The most important point, however, is that the virtual reference signal has high correlation with a certain direction or location.

### [Determination of Whether Elimination of Specific Sound Source is Completed]

In the step S13 of determining whether the elimination of a specific sound source is completed, it is determined whether the elimination of a specific sound source is completed. If completed (YES), no further operation will be performed. If not completed (NO), the sound source signal extraction step S11 and the sound source signal elimination step S12 are performed again.

### [Differences in Specific Sound Source Elimination Processing Depending on Presence or Absence of Reference Signal]

The specific sound source elimination processing varies depending on the presence or absence of a reference signal.

If there is no reference signal, a total field is calculated and displayed which is the result of calculation of the effects of all the sound sources in the sound field.

If there is a reference signal, only components that are correlated with (coherent to) the reference signal are extracted for analysis. This makes it possible to calculate and display partial fields which are the results of analysis of only components that have high correlation with each reference signal It is also possible to calculate and display a sound source eliminated field which is the result of analysis of extracted components that are irrelevant (incoherent) to the reference signal. In such a case, weak sound source signals can be emphasized.

In BF and NAH, reference signals may be used for both steady and unsteady sounds.

For steady sound, no measurement with a microphone array is needed. The input system may be composed of a 1ch reference sensor and a measurement sensor, and the measurement sensor may be moved to near the target object so that the coordinates and sound pressure can be measured by simultaneous sampling with the reference sensor. The sensor type (such as microphone and vibration pickup) and the installation location of the reference sensor need only be such that the target signal can be picked up with high fidelity. In locations where a plurality of factors contribute highly, the installation of the sensor is typically avoided since it makes separation difficult. In such a case, it is only possible to obtain partial fields correlated with the signal of the reference sensor. While virtual reference signals can be extracted by post processing, the extraction processing of the virtual reference signals is limited to a frequency domain, not in a time domain which is one of the characteristics of the present invention.

For unsteady sound, a microphone array and a reference sensor are needed for simultaneous sampling. The reference sensor may be installed as with steady sound. As mentioned previously, it is not easy to install the reference sensor in an appropriate location.

If the installation of the reference is difficult due to positional limitations, such as a reference signal near a hot object, virtual reference signals can be created according to the process of the specific sound source elimination processing as described in the present invention.

### Second Embodiment

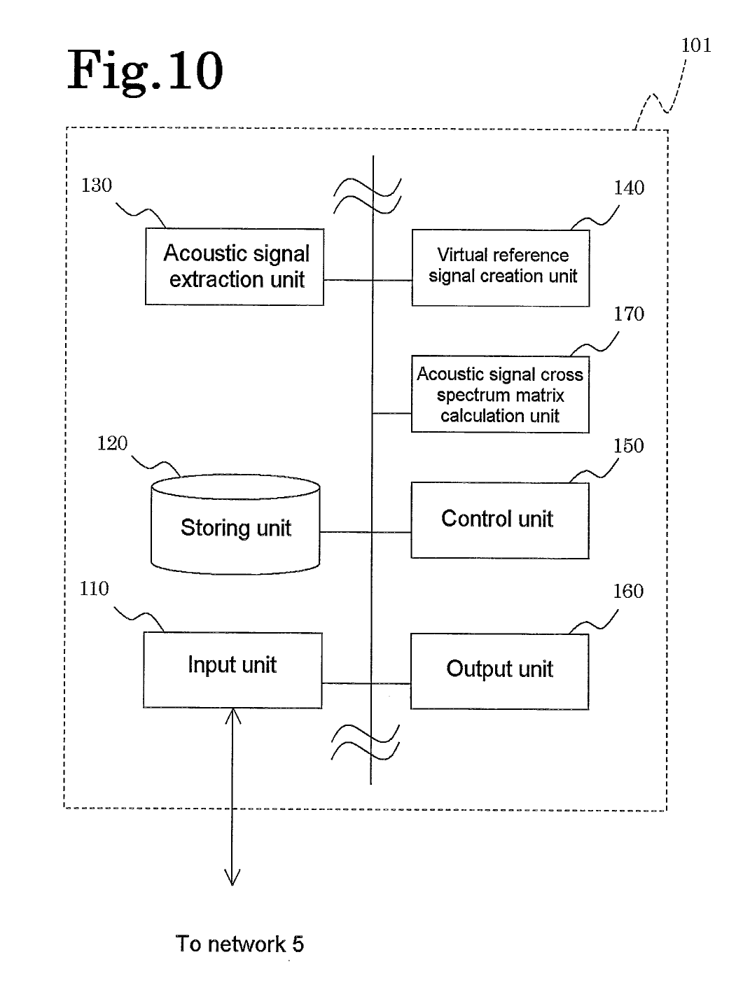

Next, a server 101 of a sound source display system according to a second embodiment of the present invention will be described with reference to FIG. 10.

The sound source display system using the server 101 has the same configuration as that of the sound source display system X according to the first embodiment shown in FIG. 1. A difference lies only in the control configuration of the server 101. The server 101 differs from the server 100 in that there is added an acoustic signal cross spectrum matrix calculation unit 170 (acoustic signal cross spectrum matrix calculating means). The other components with like reference signs are identical to those of the server 100.

The acoustic signal cross spectrum matrix calculation unit 170 is an arithmetic unit such as DSP and CPU for calculating the cross spectrum matrix of acoustic signals. Like the acoustic signal extraction unit 130 and the virtual reference signal creation unit 140 described above, the acoustic signal cross spectrum matrix calculation unit 170 may be implemented by using the arithmetic functions of the control unit 150.

In the server 101 according to the second embodiment of the present invention, the acoustic signal cross spectrum matrix calculation unit 170 is used to calculate the cross spectrum matrix of acoustic signals that are measured by the microphone array. Then, the rank (order) of the cross spectrum matrix is estimated. Such an operation is typically performed by singular value decomposition. Based on the information on the rank, the upper limit of the number of specific sound elimination operations can be determined. Consequently, sound sources that are considered to be the most appropriate can be shown in order of the magnitude of the effect, and a result in which the effects of such sound sources are eliminated can be determined automatically. Here, automatically means that the user will not visually specify any virtual reference, and that the upper limit of the number of times to eliminate arbitrary sound sources is automatically set according to the conditions of the acoustic signals recorded.

For such additional data on the acoustic signal cross spectrum matrix calculations, the server 101 may acquire the data detected by the acoustic sensors 200-1 to 200-n, may directly acquire information on other sensors, information sites, and the like from the network 5, and may directly acquire such information from a storing medium.

### [Automated Specific Sound Source Elimination Processing]

To extract a virtual reference signal corresponding to a certain position or direction, the installation position or direction is important. The installation position can be arbitrarily set by the user, desirably in a position where only the effect of a single specific sound source is predominant. In fact, it is highly likely for the user to set a virtual reference in an erroneous position. The installation of a virtual reference in an erroneous position lowers the coherence between the virtual reference and the specific sound source signal, so that the partial field extracted no longer represents the effect of the specific sound source. The installation of a virtual reference has thus been dependent on individual skills, not ensuring the reproducibility of specific sound source elimination. Then, the following processing was devised to extract a virtual reference signal without the manual elimination processing.

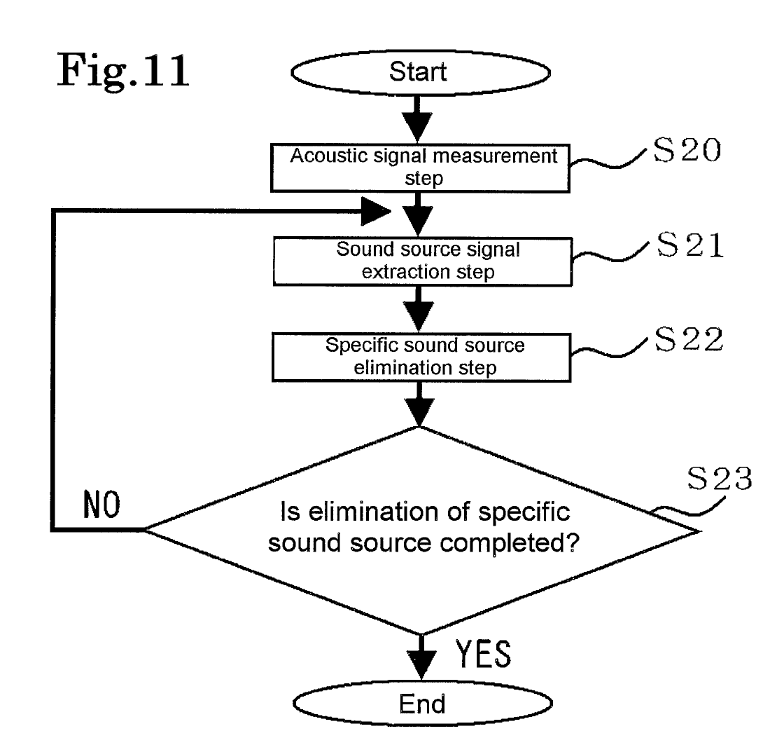

As shown in FIG. 11, the automated specific sound source elimination processing of the present invention generally includes an acoustic signal measurement step S20, a sound source signal extraction step S21, a specific sound source elimination step S22, and a step S23 of determining whether the elimination of a specific sound source is completed.

Specifically, the acoustic signal measurement step S20 performs the same processing as that of the acoustic signal measurement step S10 described in the first embodiment.

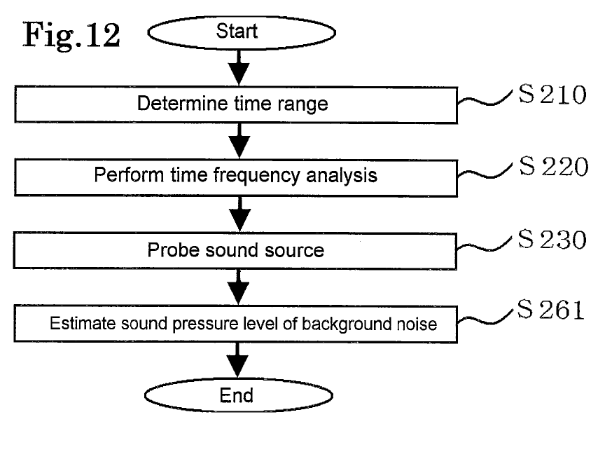

As shown in FIG. 12, the sound source signal extraction step S21 includes the determination of a time range (step S210), time frequency analysis (step S220), sound source probing (step S230), and the estimation of the sound pressure level of background noise (step S261).

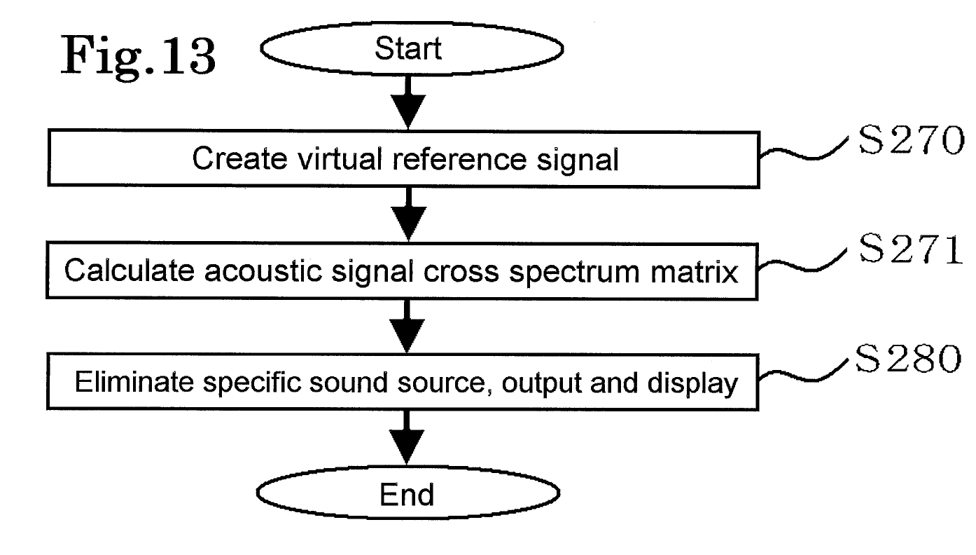

As shown in FIG. 13, the specific sound source elimination step S22 includes the creation of a virtual reference signal (step S270), acoustic signal cross spectrum matrix calculation (step S271), and the elimination of a specific sound source for output and display (step S280).

The step S23 of determining whether the elimination of a specific sound source is completed performs the same processing as that of the step S13 of determining whether the elimination of a specific sound source is completed described in the first embodiment.

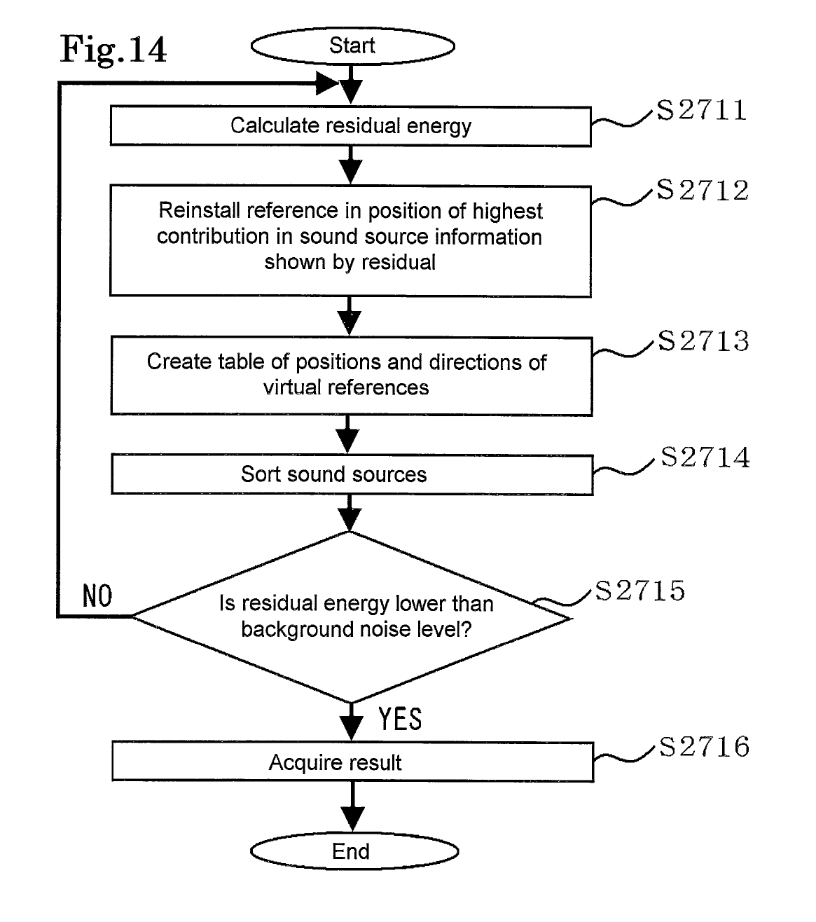

As shown in FIG. 14, the acoustic signal cross spectrum matrix calculation (step S271) includes the calculation of residual energy after the elimination of the effect of a specific sound source (step S2711), the reinstallation of a reference in a position of the highest contribution in sound source information shown by the residual (step S2712), the creation of a table of positions and directions of virtual references (step S2713), the sorting of sound sources (step S2714), the determination of whether the residual energy is lower than background noise level (step s2715), and the acquisition of a result (step S2716). The steps will be detailed below.

Step S210 performs the same processing as that of step S110 described in the first embodiment, step S220 that of step S120, and step S230 that of step S130.

### (Step S261)

The acoustic signal extraction unit 130 performs the estimation of the sound pressure level of background noise. The acoustic signal extraction unit 130 estimates the sound pressure level of the background noise when performing measurement with the microphone array. It is usually difficult to discover sound sources of extremely low energy as compared to the background noise. The sound pressure level of the background noise is used to set the upper limit of the number of times of specific sound elimination to repeat. Typically, the background noise is often measured for a verification purpose before and after an actual measurement, and such measurements may be used.

Step S270 performs the same processing as that of step S170 described in the first embodiment.

### (Step S271)

The acoustic signal cross spectrum matrix calculation unit 170 performs acoustic signal cross spectrum matrix calculation. The acoustic signal cross spectrum matrix calculation unit 170 calculates the cross spectrum matrix of acoustic signals measured by the microphone array after the measurement of the acoustic signals, before sound source probing. The acoustic signal cross spectrum matrix calculation unit 170 then estimates the rank (order) of the cross spectrum matrix typically by singular value decomposition. The rank r of the cross spectrum matrix and the number N of uncorrelated sound sources in the sound field have the relationship of r≦N (Kompella et al., “Mechanical Systems and Signal Processing,” (1994) 8 (4), 363-380). Consequently, the upper limit of the number of specific sound elimination operations repeated can be limited to within r.

Step S280 performs the same processing as that of step S180 described in the first embodiment.

Specifically, as shown in FIG. 14, the acoustic signal cross spectrum matrix calculation (step S271) further includes a specific sound elimination operation according to the following procedure.

### (Step S2711)

The acoustic signal cross spectrum matrix calculation unit 170 performs the calculation of residual energy. The acoustic signal cross spectrum matrix calculation unit 170 installs a virtual reference in a position of the highest contribution among the results of all the fields (the overall peak position), and performs a specific sound elimination operation.

### (Step S2712)

The acoustic signal cross spectrum matrix calculation unit 170 performs the reinstallation of a reference in a position of the highest contribution in the sound source information shown by the residual after the specific sound elimination operation. The acoustic signal cross spectrum matrix calculation unit 170 reinstalls a virtual reference in a position of the highest contribution in the sound source information shown by the residual and calculates the residual only if the average of the residual energy exceeds the background noise level calculated at step S2711 and the number of operations is within r.

### (Step S2713)

The acoustic signal cross spectrum calculation unit 170 creates a table of positions and directions of virtual references. The acoustic signal cross spectrum calculation unit 170 creates a table of the positions and directions of virtual references that are extracted at step S2711 and step S2712 repeatedly. The following provides an example of the table (where a spherical sound source identification and measurement apparatus was used for measurement, followed by BF analysis).

TABLE 1

| | r [m] | θ [deg] | Ø [deg] | Peak level [dB] | Residual [dB] |
|---|---|---|---|---|---|
| 1 | — | 30 | 60 | 78 | 60 |
| 2 | — | −60 | −45 | 58 | 55 |
| 3 | — | 90 | 0 | 56 | 30 |

### (Step S2714)

The acoustic signal cross spectrum matrix calculation unit 170 performs the sorting of the sound sources. The acoustic signal cross spectrum calculation unit 170 is such that the order of specific sound source elimination created in the sequence of steps S2711 to S2713 may not always be correct in terms of whether the sound sources are extracted in descending order of contribution since the virtual references are installed in positions where the sound pressure levels peak. A primary sound source that affects the result of the measurement the most is the one whose residual energy becomes the lowest after extraction (subtraction). The sound sources are therefore sorted in the following order.
(1) Subtract the effect of each virtual reference from the entire field, and assume the virtual reference of the lowest residual energy as the first virtual reference, i.e., the sound source of the highest effect.
(2) Determine the second, third, and subsequent sound sources by the same procedure.

### (Step S2715)

The acoustic signal cross spectrum matrix calculation unit 170 determines whether the residual energy is lower than the background noise level. The acoustic signal cross spectrum matrix calculation unit 170 determined whether the residual energy is lower than the background noise level after the sorting of the sound sources at step S2714. If lower (YES), no further operation will be performed. If higher (NO), the acoustic signal cross spectrum matrix calculation unit 170 returns to step S2711 and repeats the calculation to determine a sound source.

### (Step S2716)

The acoustic signal cross spectrum matrix calculation unit 170 acquires the calculations. Consequently, sound sources that are considered to be the most appropriate are automatically shown in order of the magnitude of effect by the foregoing procedure, and the results in which the effects of such sound sources are eliminated can be automatically obtained.

This reduces the possibility that virtual references may be put in non-optimum positions, thereby making it possible to ensure reproducibility and improve reliability. The upper limit of the number of times of sound source elimination can be set to perform the specific sound source elimination processing efficiently.

### EXAMPLES

Hereinafter, the present invention will be further described in conjunction with the following examples. It should be noted that the examples by no means limit the interpretation of the present invention.

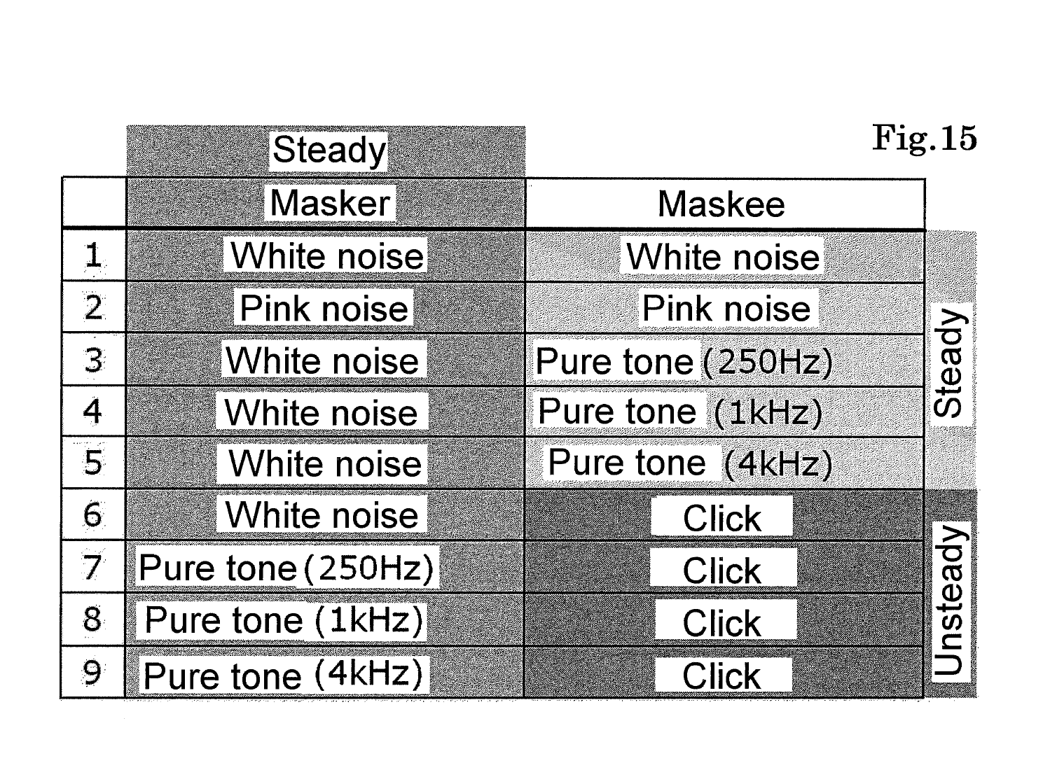

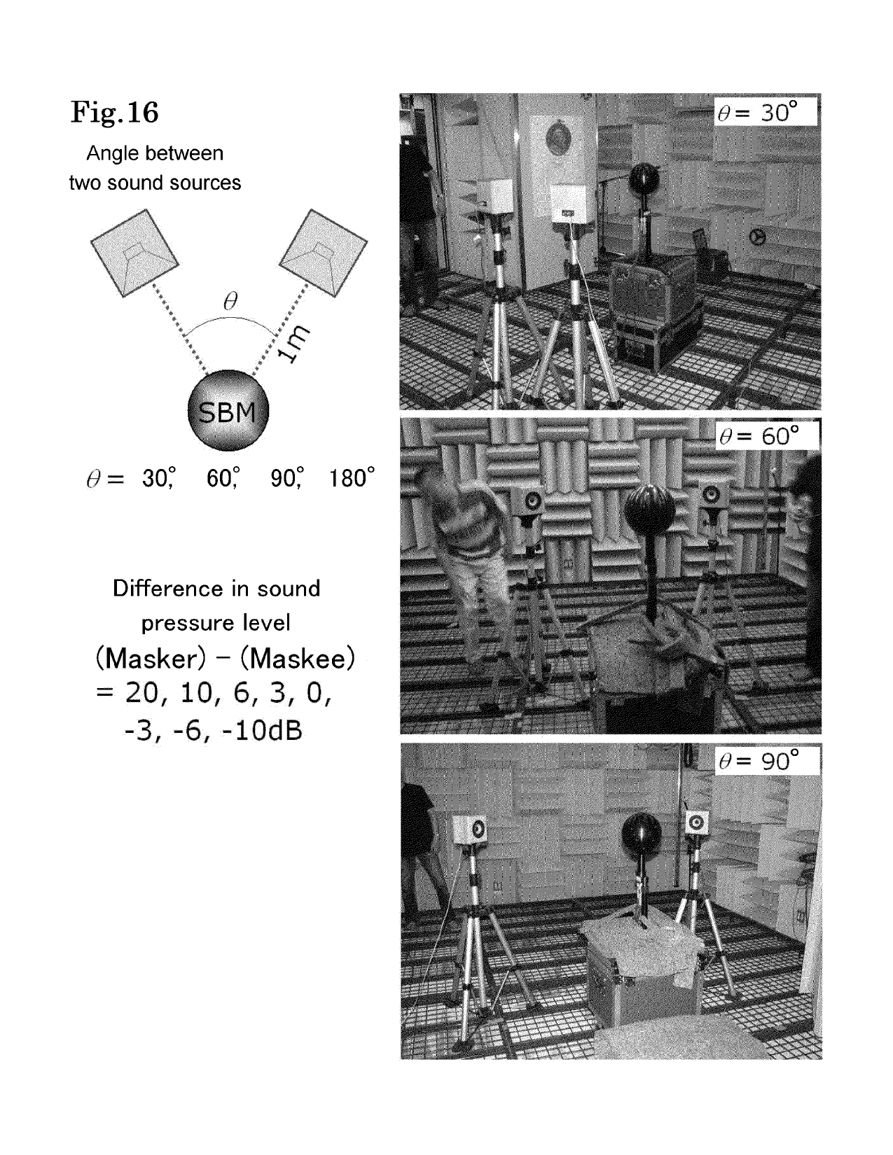

FIG. 15 shows the results of the experiments that were performed in examples 1 to 4. As schematically shown to the left in FIG. 16, two sound sources were placed in an anechoic chamber. The positions of the sound source identification and measurement apparatus and the sound sources in the actual experiments are shown to the right in FIG. 16.

### Example 1

With white noise of +20 dB as the masker on the left and white noise as the maskee on the right, the elimination of the masker was attempted by using the present invention.

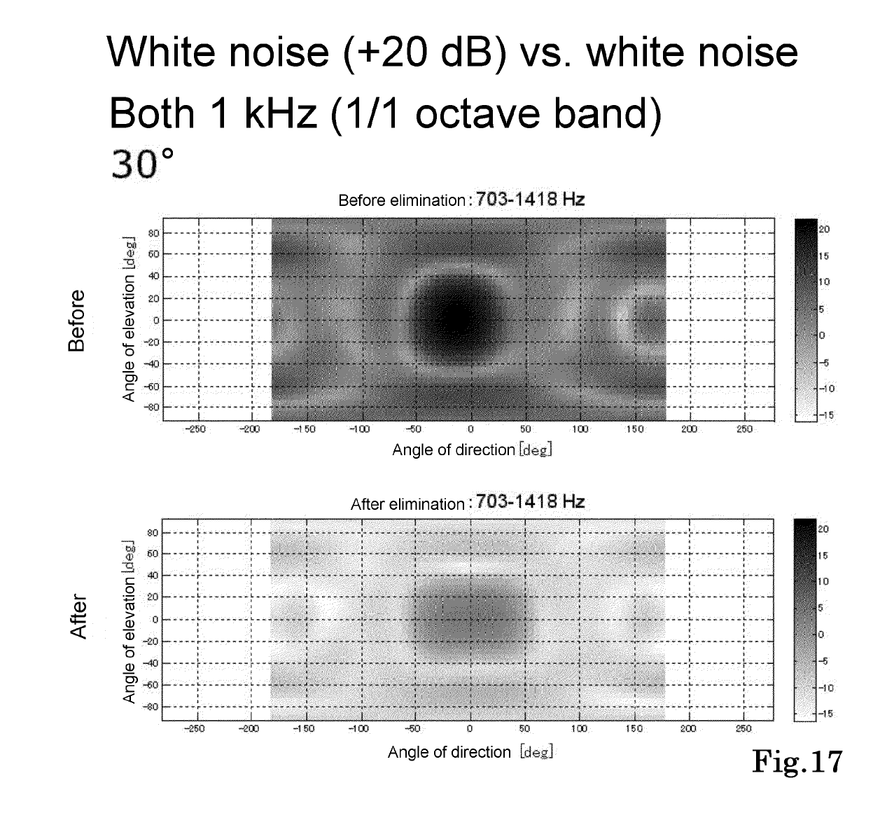

In FIGS. 17 to 20, the open angle between the sound sources was changed to check if the masker could be properly eliminated, where the masker was white noise (+20 dB) and the maskee was white noise.

FIG. 17 is a diagram showing an example of the analysis result where the open angle between the sound sources was 30°, and the masker was white noise (+20 dB) and the maskee was white noise, both of which were a 1/1 octave band with a center frequency of 1 kHz.

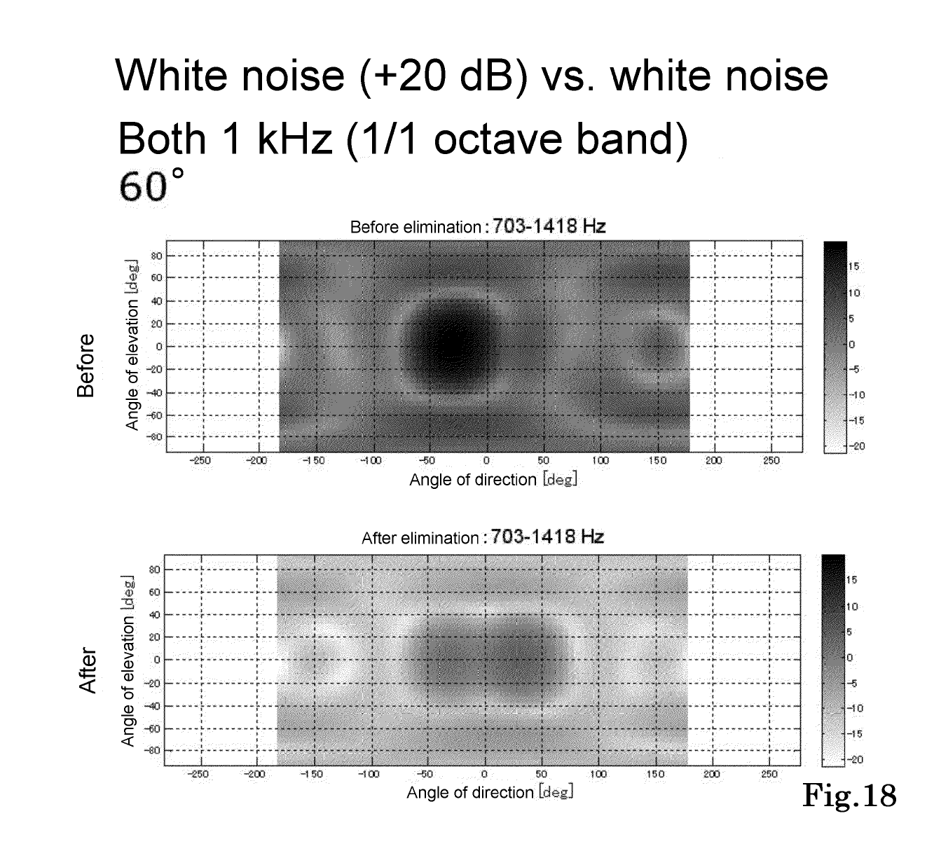

FIG. 18 is a diagram showing an example of the analysis result where the open angle between the sound sources was 60°, and the masker was white noise (+20 dB) and the maskee was white noise, both of which were a 1/1 octave band with a center frequency of 1 kHz.

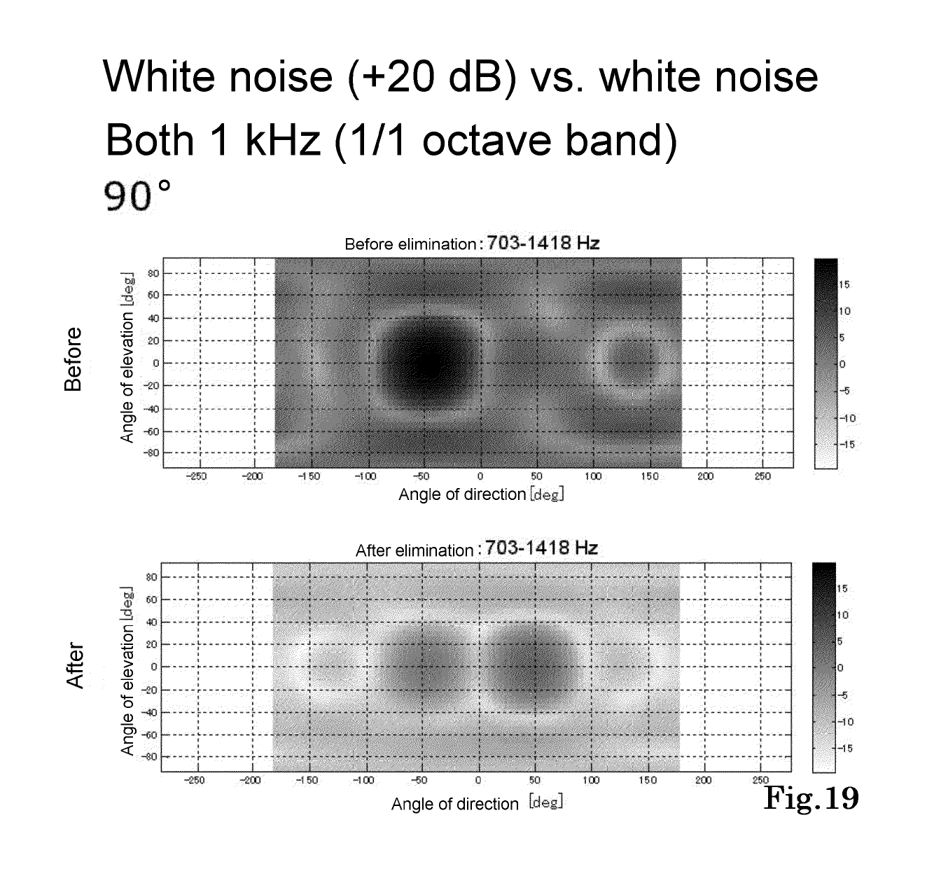

FIG. 19 is a diagram showing an example of the analysis result where the open angle between the sound sources was 90°, and the masker was white noise (+20 dB) and the maskee was white noise, both of which were a 1/1 octave band with a center frequency of 1 kHz.

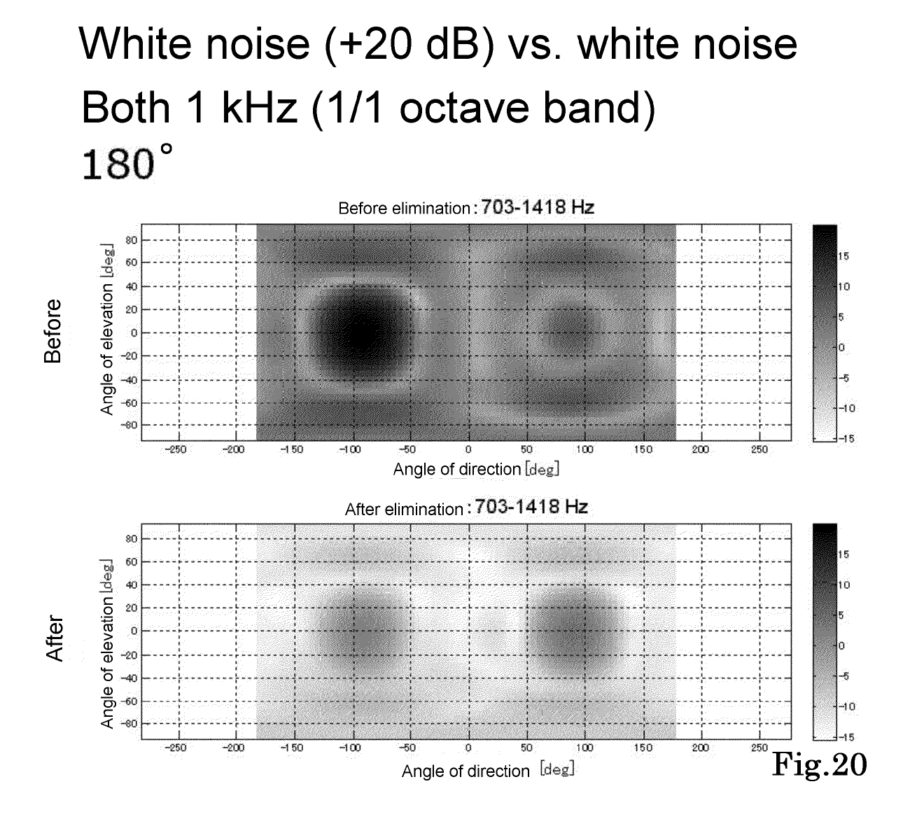

FIG. 20 is a diagram showing an example of the analysis result where the open angle between the sound sources was 180°, and the masker was white noise (+20 dB) and the maskee was white noise, both of which were a 1/1 octave band with a center frequency of 1 kHz.

In the examples of the analysis results of FIGS. 17 to 20, the left sound source was stronger before elimination. After elimination, the right was displayed stronger. That is, the maskee was displayed stronger than the masker. With white noise of +20 dB as the masker on the left and white noise as the maskee on the right, the masker elimination was properly performed regardless of the open angle between the sound sources.

### Example 2

With white noise of +20 dB as the masker on the left and a pure tone as the maskee on the right, the elimination of the masker was attempted by using the present invention.

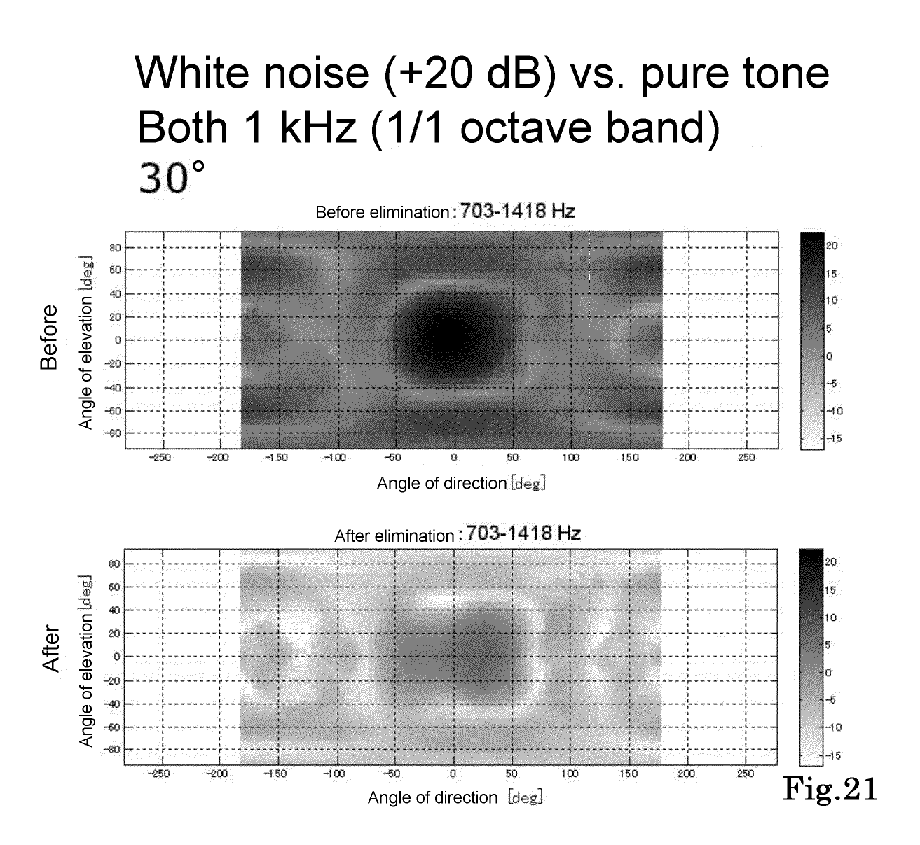

In FIGS. 21 to 24, the open angle between the sound sources was changed to check if the marker could be properly eliminated, where the masker was a 1/1 octave band of white noise (+20 dB) with a center frequency of 1 kHz, and the maskee was a pure tone of 1 kHz.

FIG. 21 is a diagram showing an example of the analysis result where the open angle between the sound sources was 30°, the masker was a 1/1 octave band of white noise (+20 dB) with a center frequency of 1 kHz, and the maskee was a pure tone of 1 kHz.

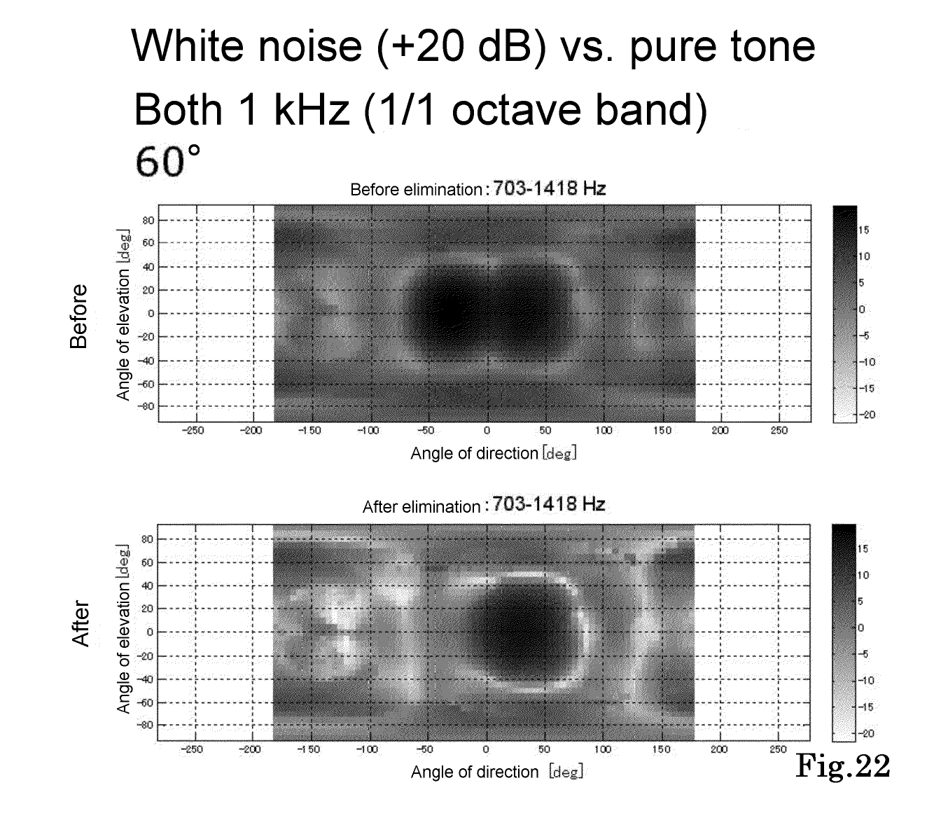

FIG. 22 is a diagram showing an example of the analysis result where the open angle between the sound sources was 60°, the masker was a 1/1 octave band of white noise (+20 dB) with a center frequency of 1 kHz, and the maskee was a pure tone of 1 kHz.

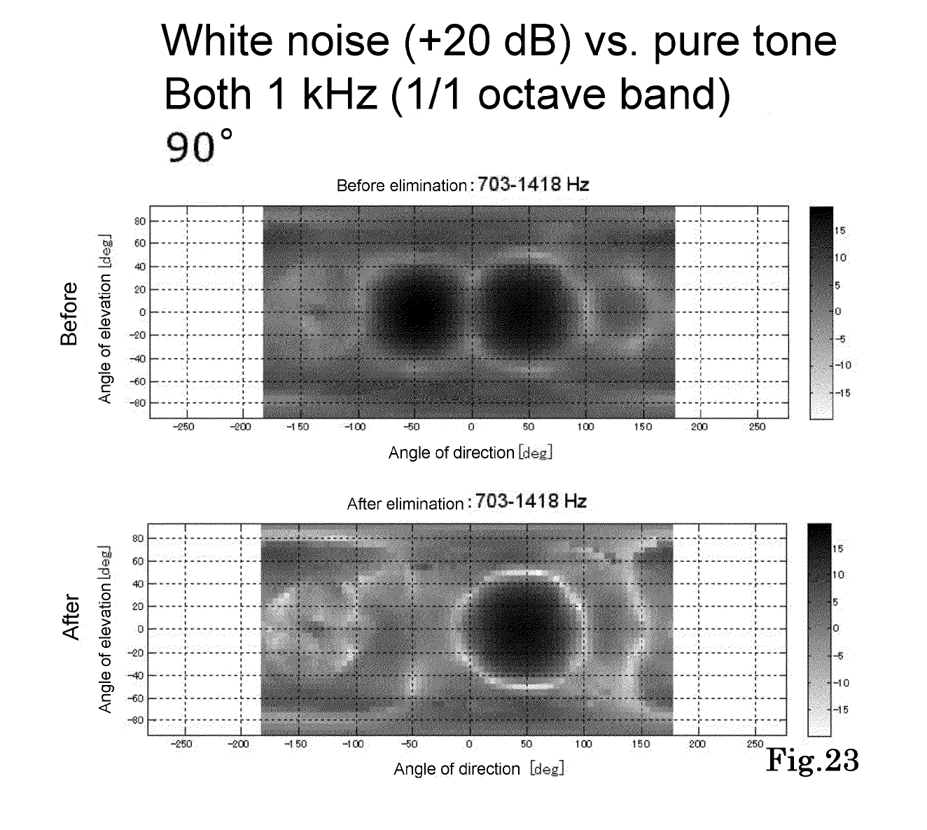

FIG. 23 is a diagram showing an example of the analysis result where the open angle between the sound sources was 90°, the masker was a 1/1 octave band of white noise (+20 dB) with a center frequency of 1 kHz, and the maskee was a pure tone of 1 kHz.

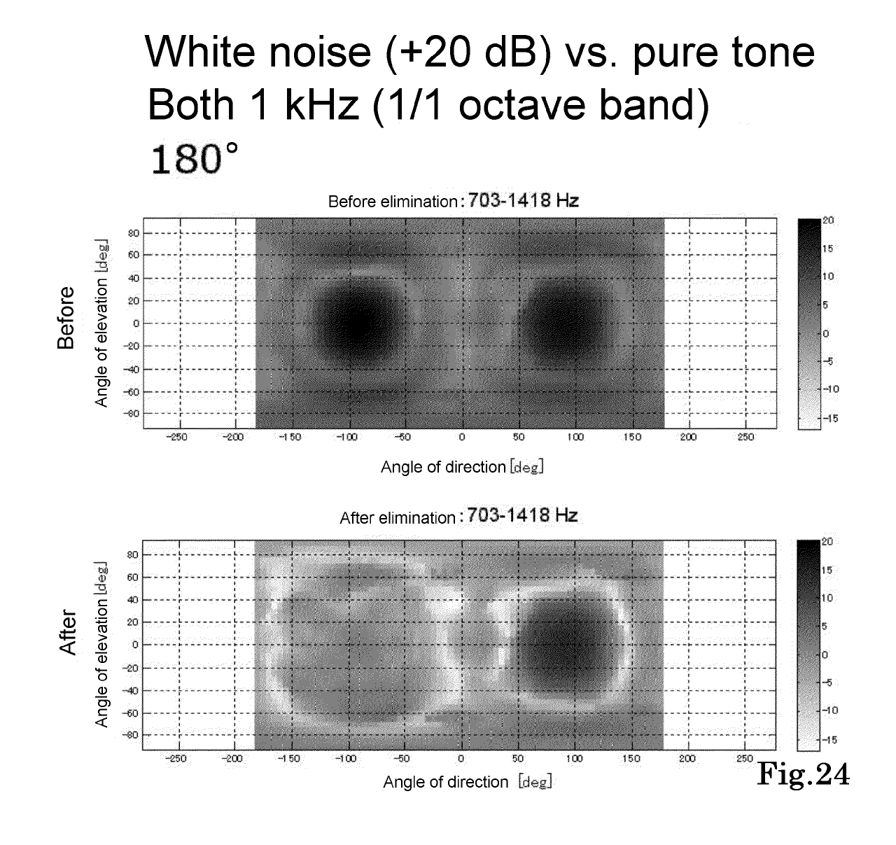

FIG. 24 is a diagram showing an example of the analysis result where the open angle between the sound sources was 180°, the masker was a 1/1 octave band of white noise (+20 dB) with a center frequency of 1 kHz, and the maskee was a pure tone of 1 kHz.

In the examples of the analysis results of FIGS. 21 to 24, the left sound source was stronger before elimination. After elimination, the right was displayed stronger. That is, the maskee was displayed stronger than the masker. With white noise of +20 dB as the masker on the left and a pure tone as the maskee on the right, the masker elimination was properly performed regardless of the open angle between the sound sources.

### Example 3

With white noise of +20 dB as the masker on the left and a click or impulsive sound as the maskee on the right, the elimination of the masker was attempted by using the present invention.

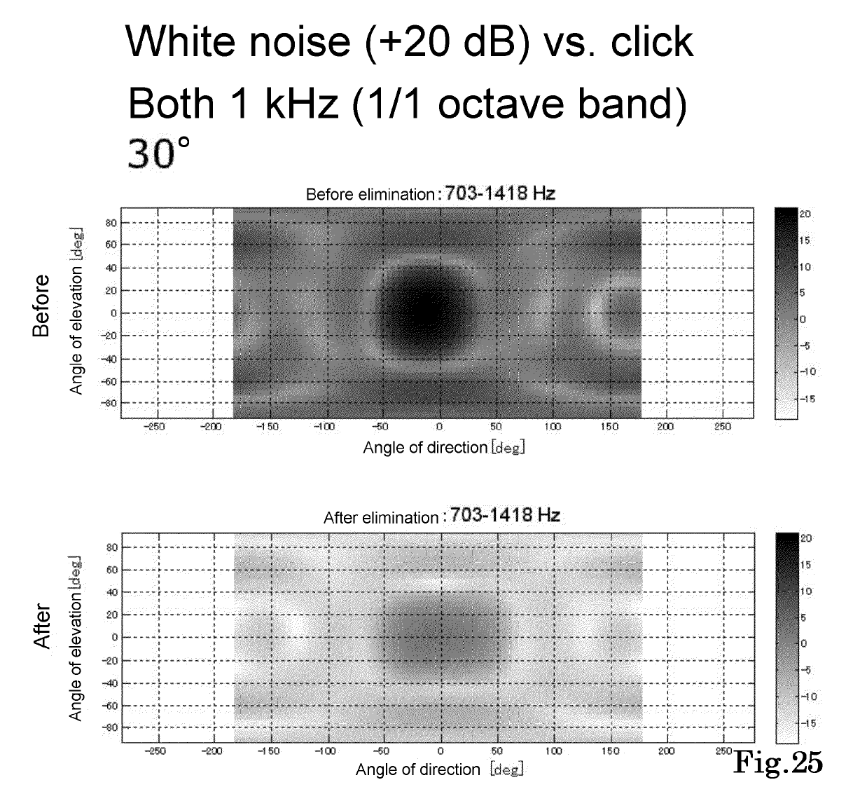

In FIGS. 25 to 28, the open angle between the sound sources was changed to check if the marker could be properly eliminated, where the masker was a 1/1 octave band of white noise (+20 dB) with a center frequency of 1 kHz, and the maskee was a click or impulsive sound.

FIG. 25 is a diagram showing an example of the analysis result where the open angle between the sound sources was 30°, the masker was a 1/1 octave band of white noise (+20 dB) with a center frequency of 1 kHz, and the maskee was a click or impulsive sound.

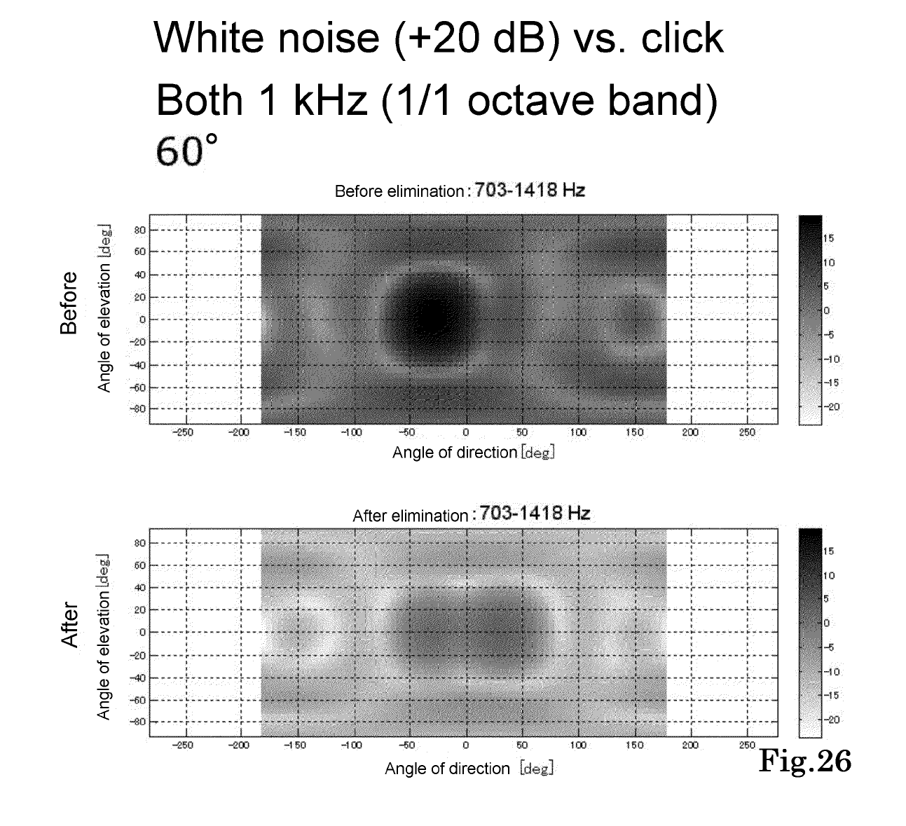

FIG. 26 is a diagram showing an example of the analysis result where the open angle between the sound sources was 60°, the masker was a 1/1 octave band of white noise (+20 dB) with a center frequency of 1 kHz, and the maskee was a click or impulsive sound.

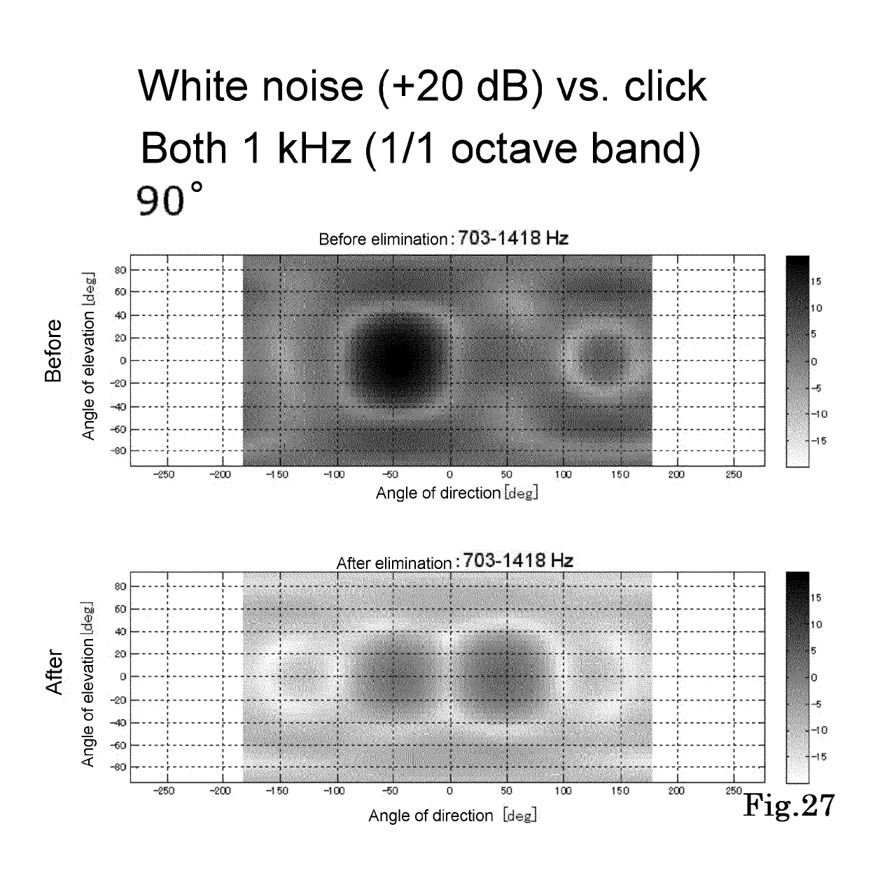

FIG. 27 is a diagram showing an example of the analysis result where the open angle between the sound sources was 90°, the masker was a 1/1 octave band of white noise (+20 dB) with a center frequency of 1 kHz, and the maskee was a click or impulsive sound.

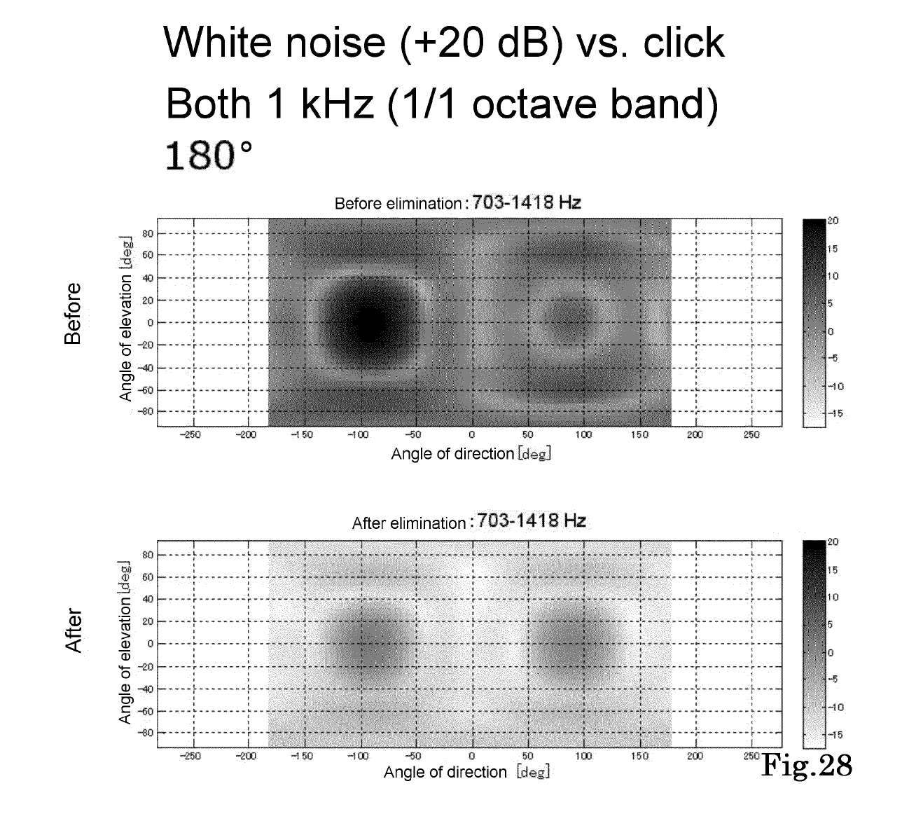

FIG. 28 is a diagram showing an example of the analysis result where the open angle between the sound sources was 180°, the masker was a 1/1 octave band of white noise (+20 dB) with a center frequency of 1 kHz, and the maskee was a click or impulsive sound.

In the examples of the analysis results of FIGS. 25 to 28, the left sound source was stronger before elimination. After elimination, the right was displayed stronger. That is, the maskee was displayed stronger than the masker. With white noise of +20 dB as the masker on the left and a click or impulsive sound as the maskee on the right, the masker elimination was properly performed regardless of the open angle between the sound sources.

### Example 4

With a pure tone of +20 dB as the masker on the left and a click or impulsive sound as the maskee on the right, the elimination of the masker was attempted by using the present invention.

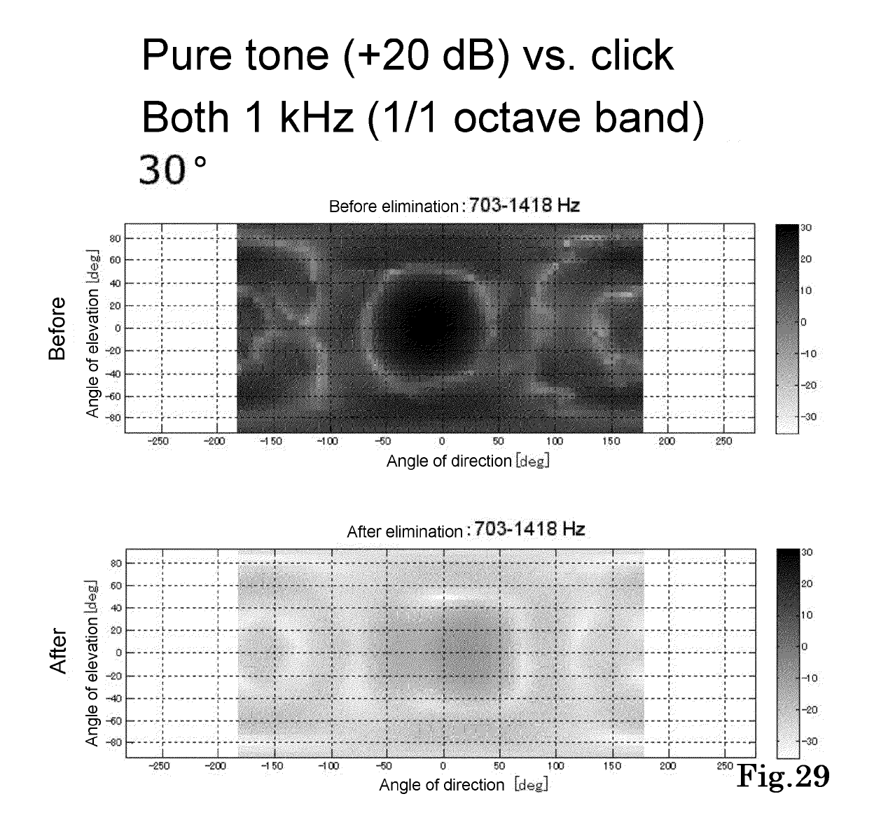

In FIGS. 29 to 32, the open angle between the sound sources was changed to check if the marker could be properly eliminated, where the masker was a pure tone of 1 kHz (+20 dB) and the maskee was a click or impulsive sound.

FIG. 29 is a diagram showing an example of the analysis result where the open angle between the sound sources was 30°, the masker was a pure tone of 1 kHz (+20 dB), and the maskee was a click or impulsive sound.

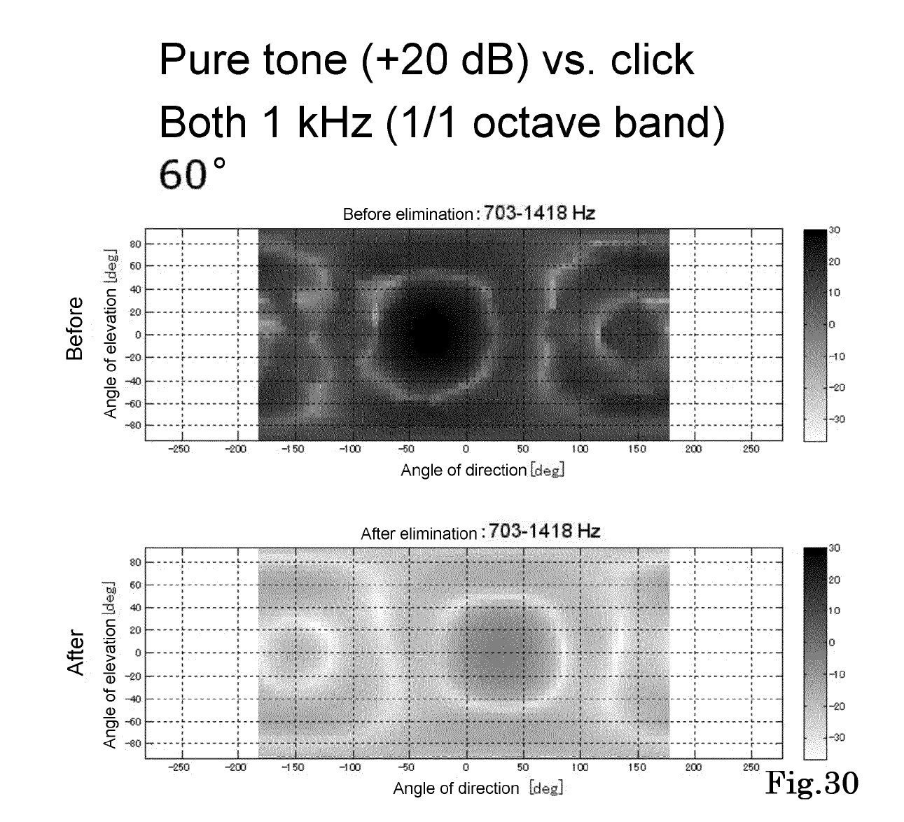

FIG. 30 is a diagram showing an example of the analysis result where the open angle between the sound sources was 60°, the masker was a pure tone of 1 kHz (+20 dB), and the maskee was a click or impulsive sound.

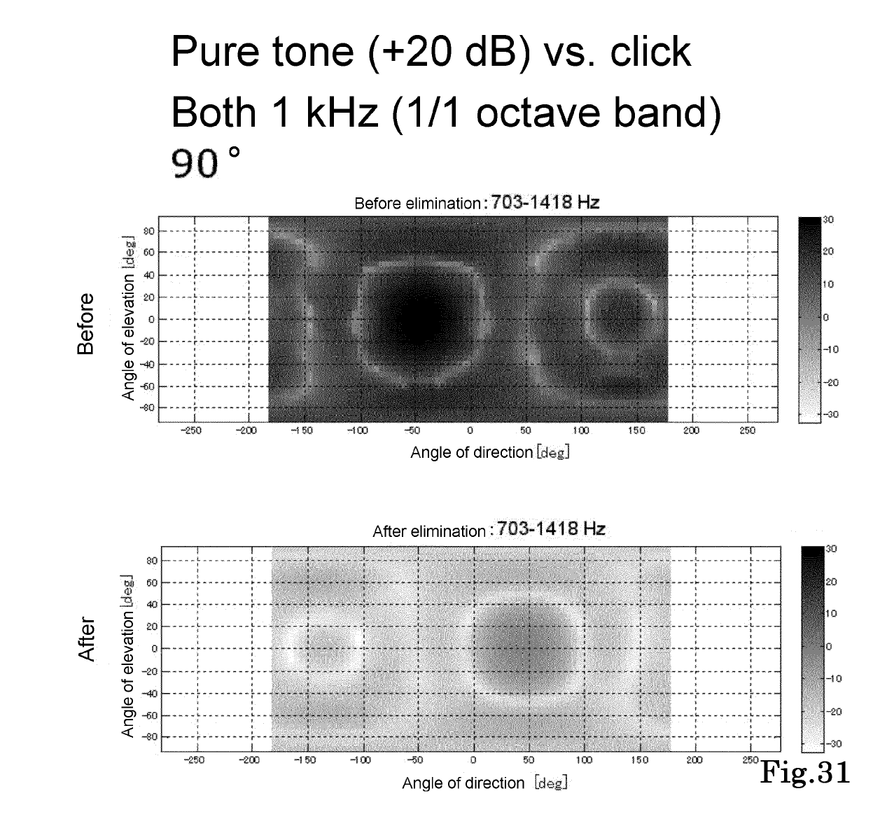

FIG. 31 is a diagram showing an example of the analysis result where the open angle between the sound sources was 90°, the masker was a pure tone of 1 kHz (+20 dB), and the maskee was a click or impulsive sound.

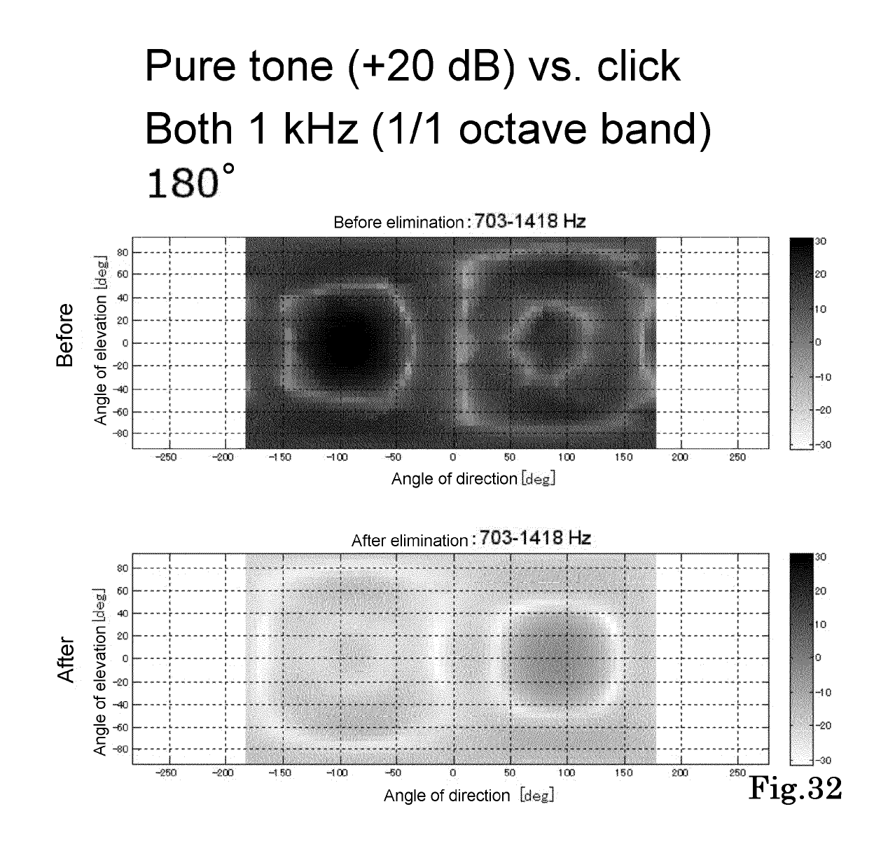

FIG. 32 is a diagram showing an example of the analysis result where the open angle between the sound sources was 180°, the masker was a pure tone of 1 kHz (+20 dB), and the maskee was a click or impulsive sound.

In the examples of the analysis results of FIGS. 29 to 32, the left sound source was stronger before elimination. After elimination, the right was displayed stronger. That is, the maskee was displayed stronger than the masker. With a pure tone of ₊20 dB as the masker on the left and a click or impulsive sound as the maskee on the right, the masker elimination was properly performed regardless of the open angle between the sound sources.

### Example 5

Among typical tests of automotive vehicle interior noise is a bench test using a chassis dynamometer. The test can measure the behavior of the vehicle under engine rotations and load that simulate actual driving, and is also widely used for the purpose of noise evaluation. Here, an example will be given of a test for engine noise under acceleration.

In the test, a passenger automobile is placed on the rollers of the chassis dynamometer. The roller surfaces are covered with antiskid surfaces, whose asperities produce no noticeable road noise (noise caused by contact between the tires and the road surface). In such a case, the automobile can be put into a driving state to yield an engine load under acceleration, which makes the noise evaluation possible. The following provides the measurements when the transmission was set to the third gear and the engine was maintained at 3000 rpm. The microphone array was installed on the passenger seat.

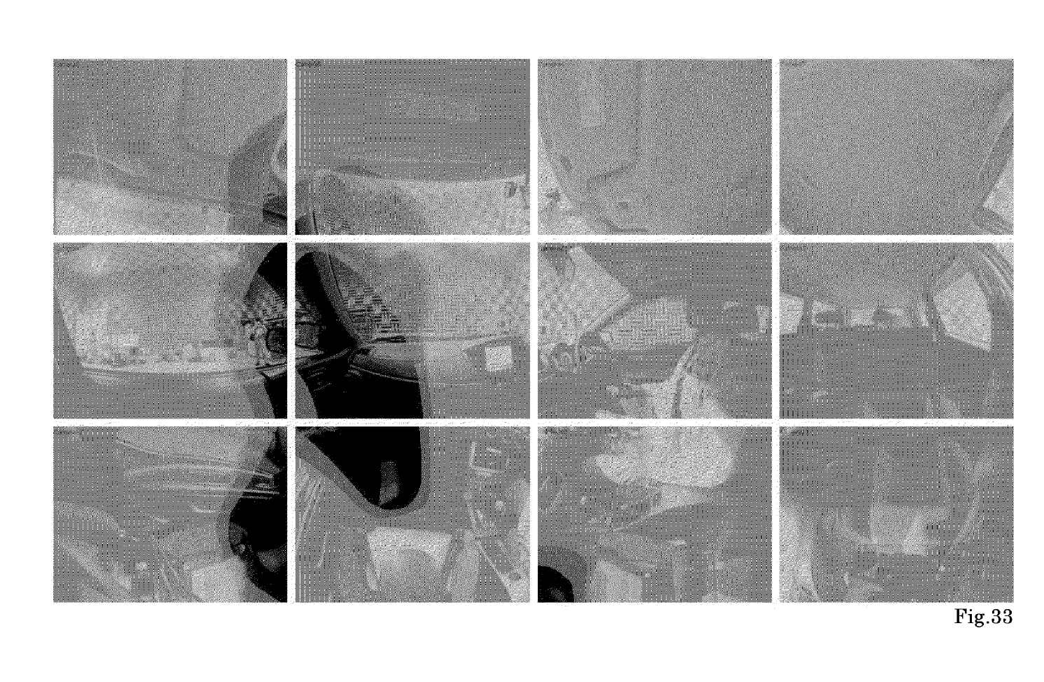

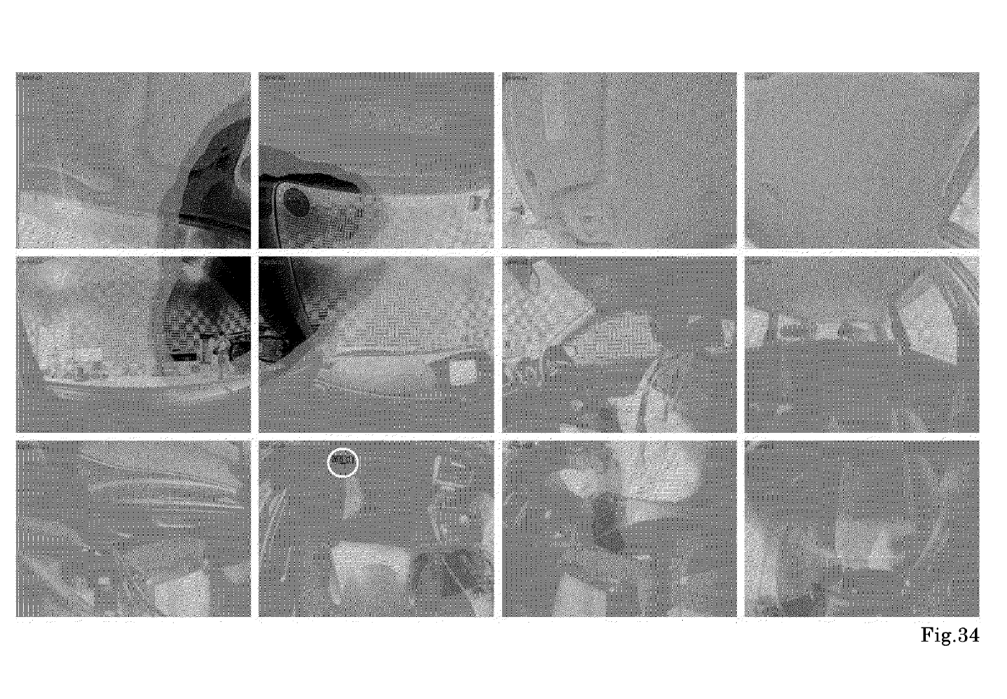

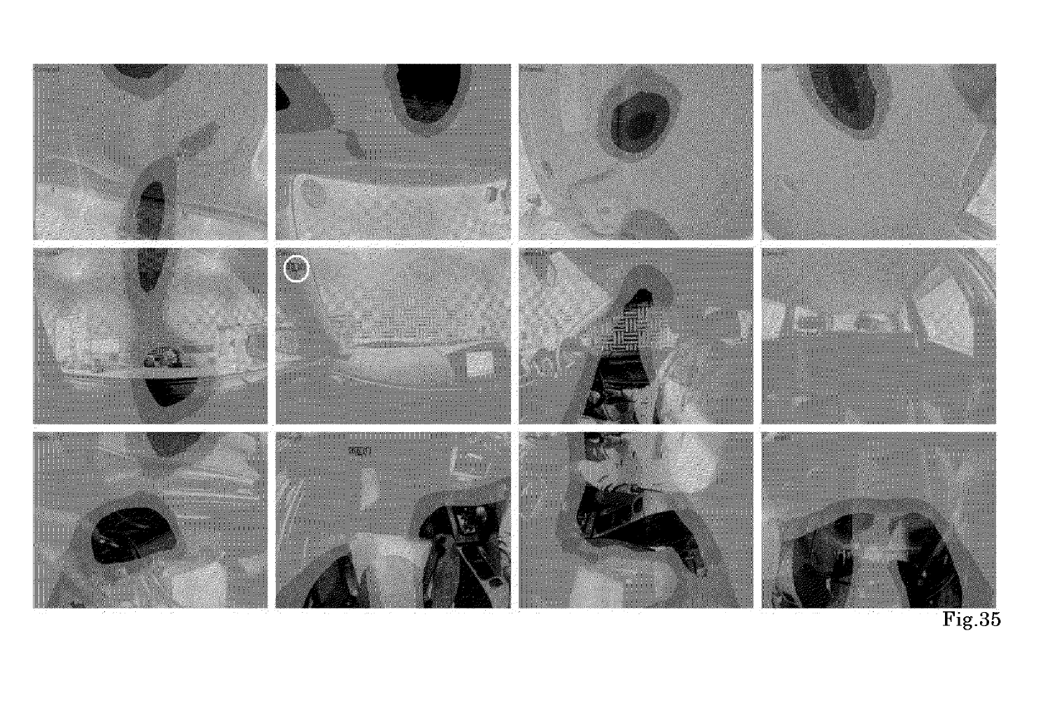

FIG. 33 shows the calculations of a total field, which do not depend on any particular reference signal, as superposed on photographs. The frequency was 800 Hz. It can be seen that the engine noise penetrates into and affects the vehicle interior through the dash panel. The peak shown in the diagram represents the primary noise contribution. If the effect of the sound radiated from the dash panel can be eliminated, it is possible to locate a next problem without an additional experiment. Applying the specific sound source elimination of the present invention to the peak on the dash panel (see the while circle in screen 9 of FIG. 34) produces FIG. 34. FIG. 34 shows noise contribution from the part of an A-pillar (a structural component on a pillar that is erected from the mounting position of a door mirror to the roof). FIG. 35 shows the result of elimination of the noise contribution from the A-pillar part of FIG. 34 (see the white circle in screen 1 of FIG. 35).

As seen above, the present invention can be used to eliminate a primary sound source (masker) to discover a hidden sound source (maskee) even with automotive noises.

### Example 6

For the sake of comparison between when the user puts an extraction point in an optimum position and when in a non-optimum point, description will be given of a case similar to example 5, where the sound source identification and measurement apparatus was used to perform the specific sound source elimination processing on vehicle interior noise lying around the sound source identification and measurement apparatus. Hereinafter, examples of the analysis results of the specific sound source elimination processing on the vehicle interior noise will be described with reference to the drawings.

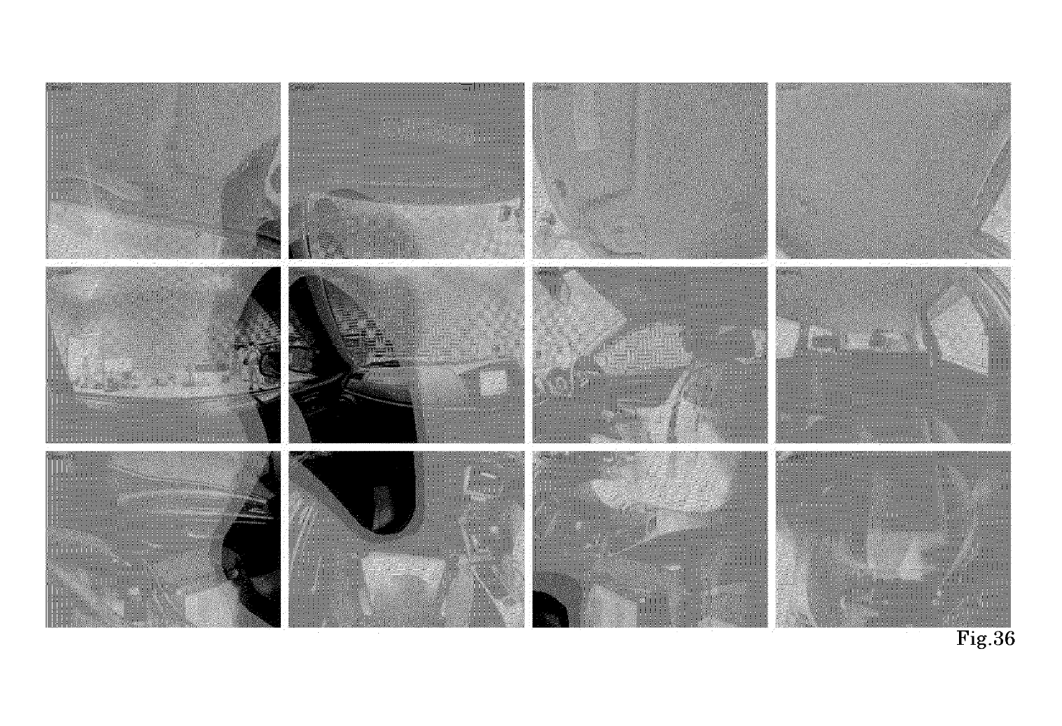

FIGS. 36 to 38 show the examples of the analysis results of the sound source identification and measurement apparatus, showing the sound levels of the vehicle interior noise in all directions of the sound source identification and measurement apparatus in combination with actual vehicle interior images. The examples of the analysis results show the comparison between when the user puts the extraction point in an optimum position and when in a non-optimum position with respect to the location of the sound source.

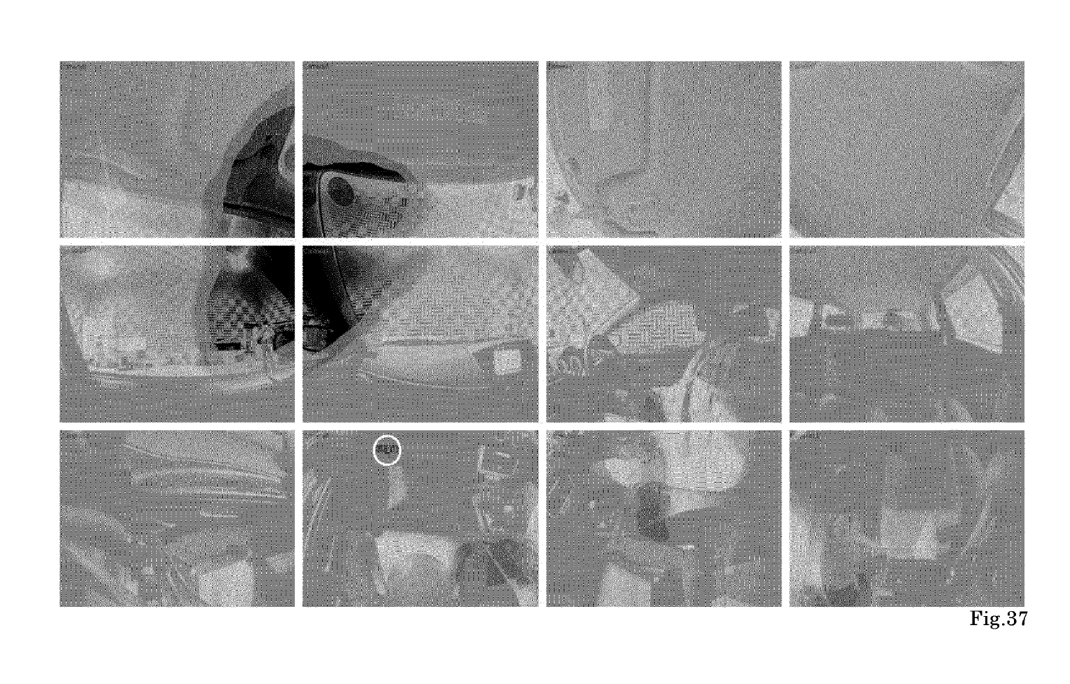

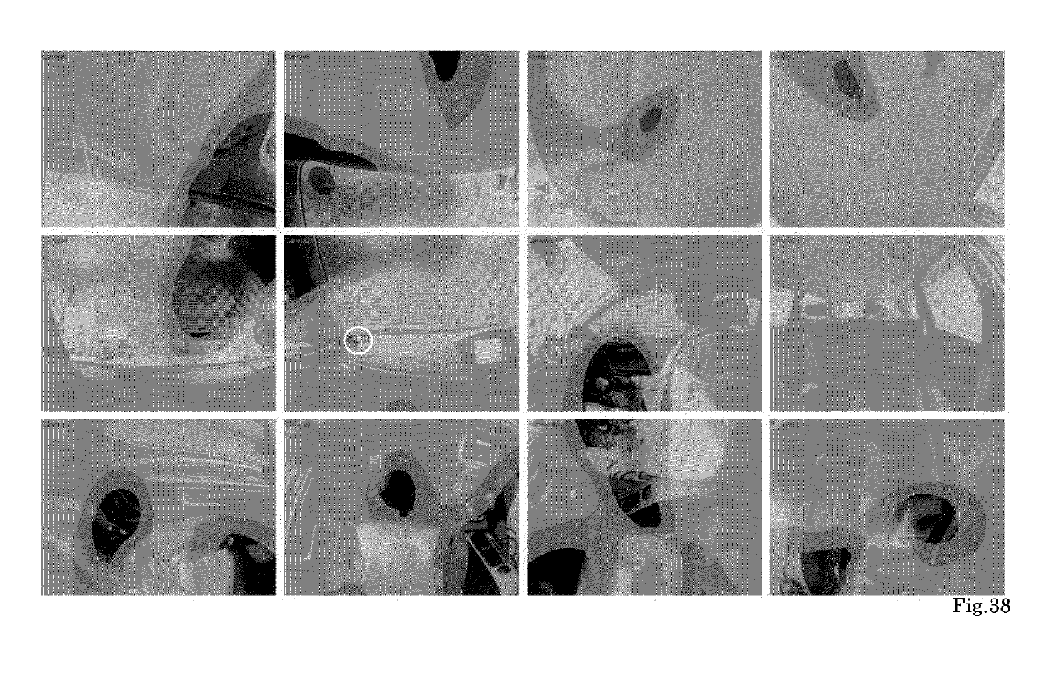

FIG. 36 shows the sound levels before the sound source elimination processing, in combination with the actual vehicle interior images. FIG. 37 shows an example of the result of the sound source elimination processing when the user puts the extraction point in an optimum position (see the white circle in screen 9 of FIG. 37). FIG. 38 shows an example of the result of the sound source elimination processing when the user puts the extraction point in a non-optimum position (see the white circle in screen 1 of FIG. 38).

As shown in FIG. 37, when the user puts the extraction point in an optimum position, the sound source appearing on the screen is appropriately eliminated. On the other hand, as shown in FIG. 38, when the user puts the extraction point in a non-optimum position, the sound source appearing on the screen is not appropriately eliminated and a lot of peaks appear in FIG. 38 which is the result of the specific sound source elimination operations. As can be seen, when the user by himself/herself locates the sound source for elimination, an appropriate result is not obtained unless the optimum position is pointed out.

Using the present invention, it is possible to accurately perform the specific sound source elimination processing without the user specifying the extraction point. According to such a procedure, it is possible to automate the process of example 5 and provide the same result as in embodiment 5. In this example, the cross spectrum matrix at 800 Hz had a rank of 3, and the background noise level was 15 dB. After the specific sound source elimination of example 5 was actually performed twice, the residual energy was 12 dB. A comparison with the background noise shows that a further specific sound elimination is difficult. That is, it is clear that the same result as in example 5 can be obtained by using the automated technique of the present invention.

It will be understood that the configurations, analyses, and measurements of the foregoing embodiments are just a few examples, and appropriate modifications may be made without departing from the gist of the present invention.

It will be understood by those skilled in the art that the processing procedures shown with the configurations, analyses, and measurements of the foregoing embodiments also provide the functions of the foregoing embodiments even when part or all of the actual processing is performed or the order of the processing procedures or steps is modified.

1. A sound source separation and display method comprising:
an acoustic signal measurement step of measuring acoustic signals by using a plurality of acoustic sensors;
a sound source signal extraction step of performing processing to identify one or a plurality of sound sources from the measured acoustic signals, and extracting a sound source signal in a certain incoming direction or at a certain location; and
a specific sound source elimination step of eliminating an effect of a specific sound source from the measured acoustic signals by separating a component correlated with a virtual reference signal from the measured acoustic signals with the signal extracted by the sound source signal extraction step as the virtual reference signal, and performing the processing to identify one or a plurality of sound sources again on the signals from which the effect of the specific sound source is eliminated and separated, thereby eliminating only the effect of the specific sound source from a result of the processing to identify the sound source(s),
the method being capable of displaying a sound source separated.

2. The sound source separation and displaying method according to claim 1, wherein the sound source signal extraction step and the specific sound source elimination step are performed a plurality of times.

3. The sound source separation and displaying method according to claim 1 or 2, wherein the specific sound source elimination step estimates the certain incoming direction or a position of the specific sound source and calculates magnitudes of effects of the plurality of sound sources in order to create the virtual reference signal.

4. The sound source separation and displaying method according to claim 1, wherein the specific sound source elimination step estimates a rank of a cross spectrum matrix of the acoustic signals, and determines an upper limit of the number of times of elimination, the rank pertaining to the number of uncorrelated sound sources.

5. The sound source separation and displaying method according to claim 1, wherein the sound source(s) is/are visualized in combination with images captured by light receiving elements that are arranged like the acoustic sensors.

6. A sound source separation and display system capable of displaying:
an acoustic signal measuring means for measuring acoustic signals by using a plurality of acoustic sensors;
a sound source signal extracting means for performing processing to identify one or a plurality of sound sources from the measured acoustic signals, and extracting a sound source signal in a certain incoming direction or at a certain location;
a specific sound source eliminating means for eliminating an effect of a specific sound source from the measured acoustic signals by separating a component correlated with a virtual reference signal from the measured acoustic signals with the signal extracted by said sound source signal extracting means as the virtual reference signal, and performing the processing to identify one or a plurality of sound sources again on the signals from which the effect of the specific sound source is eliminated and separated, thereby eliminating only the effect of the specific sound source from a result of the processing to identify acoustics; and
a sound source separated.

7. The sound source separation and displaying system according to claim 6, wherein said sound source signal extracting means and said specific sound source eliminating means are performed a plurality of times.

8. The sound source separation and displaying system according to claim 6 or 7, wherein said specific sound source eliminating means includes a means for estimating an incoming direction of a certain sound wave or a position of the specific sound source and calculating magnitudes of effects of the plurality of sound sources in order to create the virtual reference signal.

9. The sound source separation and displaying system according to claim 6, wherein said specific sound source eliminating means includes a means for estimating a rank of a cross spectrum matrix of the acoustic signals, and determining an upper limit of the number of times of elimination, the rank pertaining to the number of uncorrelated sound sources.

10. The sound source separation and displaying system according to claim 6, comprising a means for visualizing the sound source(s) in combination with images captured by light receiving elements that are arranged like the acoustic sensors.
